(19) United States
(12) Patent Application Publication
(10) Pub. No.: US 2013/0297528 A1
(43) Pub. Date: Nov. 7, 2013

(54) BUSINESS PROCESS MODEL NOTATION EXTENSION FOR MODELING OF INTEGRATION PROCESSES

(71) Applicant: Volker Stiehl, Moehrendorf (DE)

(72) Inventor: Volker Stiehl, Moehrendorf (DE)

(73) Assignee: SAP AG

(21) Appl. No.: 13/464,641

(22) Filed: May 4, 2012

(51) Int. Cl. G06Q 10/06

(52) U.S. Cl. 705/348

(57) ABSTRACT

Computer implemented methods and computer program products involve instructions including identifying a business process model. An integration process definition can be identified. The integration process definition can be integrated into the business process model. An enhanced business process model can be defined, the enhanced business process model including the business process model and the integration process definition.

### FIELD

The present disclosure pertains to software, computer systems, and computer-implemented methods for providing Business Process Model and Notation (BPMN) extensions for modeling integration processes, and more particularly, to BPMN-based domain specific language for integration processes.

### BACKGROUND

Due to its rich set of technical shapes, the Business Process Model and Notation (BPMN) is useful for modeling business processes. BPMN facilitates the sequence control of process flows, as well as the associated message flow within the process itself and with external partners in the form of collaboration diagrams.

### SUMMARY

Certain implementations of computer-implemented methods and systems and computer program products executing instructions tangibly stored on non-transitory media may include identifying a business process model and an integration process definition. The integration process definition may be incorporated into the business process model. An enhanced business process model may be identified and may include the business process model and the integration process definition. In certain aspects of the implementations, the integration process definition may be represented as a visual icon in the enhanced business process model. In certain aspects of the implementations, the integration process definition may define a message aggregation process, the message aggregation process operable when executed to combine multiple messages into a single message. In certain aspects of the implementations, the integration process definition may define a content enrichment process, the content enrichment process operable when executed to add data to an in-coming message. In certain aspects of the implementations, the integration process definition may define a content filter process, the content filter process operable when executed to remove data from an incoming message. In certain aspects of the implementations, the integration process definition may define a message translator process, the message translator process operable when executed to transform data from one form to another form. In certain aspects of the implementations, the integration process definition may define a content-based router process, the content-based router process operable when executed to route a message to a recipient based on content within the message. In certain aspects of the implementations, the integration process definition may define a recipient list process, the recipient list process operable when executed to transfer messages to one or more recipients. In certain aspects of the implementations, the integration process definition may define a message filter process, the message filter process operable when executed to remove a message. Certain aspects of the implementations may also include identifying a data object associated with the business process model. The data object may be enhanced by an integration process definition. The enhanced data object in association with the enhanced business process model. In certain aspects, an event message type, a document message type, and/or a command message type can be defined, the message types can be enhanced with a integration process definition. In certain aspects, an association between a task of the business process model and an implementation icon can be defined, the implementation icon identifying how the task is to be performed. The association is one or more of a service, a business rule, or a script.

While generally described as computer implemented software embodied on non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF THE DRAWINGS

FIG. 1 is a schematic diagram illustrating an example environment for implementing various features of a system for providing BPMN extensions for integration processes.

FIG. 2 is a graphical representation of an enterprise integration pattern.

FIG. 3 is a schematic illustration of a BPMN process model incorporating an aggregator pattern subprocess.

FIG. 4 is a schematic illustration of certain details of the Aggregator Subprocess.

FIG. 5 is a schematic illustration showing the details of the aggregator implementation when using the aggregator in a processing chain.

FIG. 6 is a schematic illustration of a BPMN process model incorporating a content enricher pattern.

FIG. 7 is a schematic illustration of a BPMN process model incorporating a content filter pattern.

FIG. 8 is a schematic illustration of a BPMN process model incorporating a message translator pattern.

FIG. 9 is a schematic illustration of a BPMN process model incorporating a content-based router pattern.

FIG. 10 is a schematic illustration of a BPMN process model incorporating a message filter pattern.

FIG. 11A is a schematic illustration of a BPMN process model incorporating a recipient list pattern using conditional flows.

FIG. 11B is a schematic illustration of a BPMN process model incorporating a recipient list pattern using an inclusive gateway.

FIG. 12 is a schematic illustration of a BPMN process model incorporating a resequencer pattern subprocess.

FIG. 13 is a schematic illustration showing the detailed implementation of the Resequencer subprocess.

FIG. 14 is a schematic illustration showing the detailed implementation of the resequencer subprocess when using the resequencer in a processing chain (message receipt as the first step).

FIG. 15 is a schematic illustration of an example BPMN process model incorporating a splitter pattern.

FIG. 16 is a schematic illustration of a composed message processor pattern.

FIG. 17 is a schematic illustration of a composed message processor pattern using extended BPMN.

FIG. 18 is a schematic illustration of a scatter-gather pattern.

FIG. 19 is a schematic illustration of a BPMN process incorporating the scatter-gather pattern using extended BPMN.

FIG. 20 is a schematic illustration showing the differentiation of process integration symbols for event-message, document-message, and command-message patterns in accordance with the present disclosure.

FIG. 21 is a schematic illustration of message processing flow using pattern symbols.

FIG. 22 is a schematic illustration showing the corresponding process flow, implemented with extended BPMN.

FIG. 23 is a schematic illustration of complex order processing using extended BPMN.

FIG. 24 is a process flow diagram for defining an enhanced business process model that incorporates a process integration pattern.

### DETAILED DESCRIPTION

This disclosure generally pertains to software, computer systems, and computer-implemented methods for providing Business Process Model and Notation (BPMN) extensions for modeling integration processes, and more particularly, to BPMN-based domain specific language for integration processes. BPMN modeling can be enhanced using integration process notation, such as those described by Hohpe and Woolf, Enterprise Integration Patterns (2004). BPMN's wide range of technically-oriented components facilitate the implementation of integration processes into BPMN process models, and in particular, for the inclusion of enterprise integration patterns into BPMN process models.

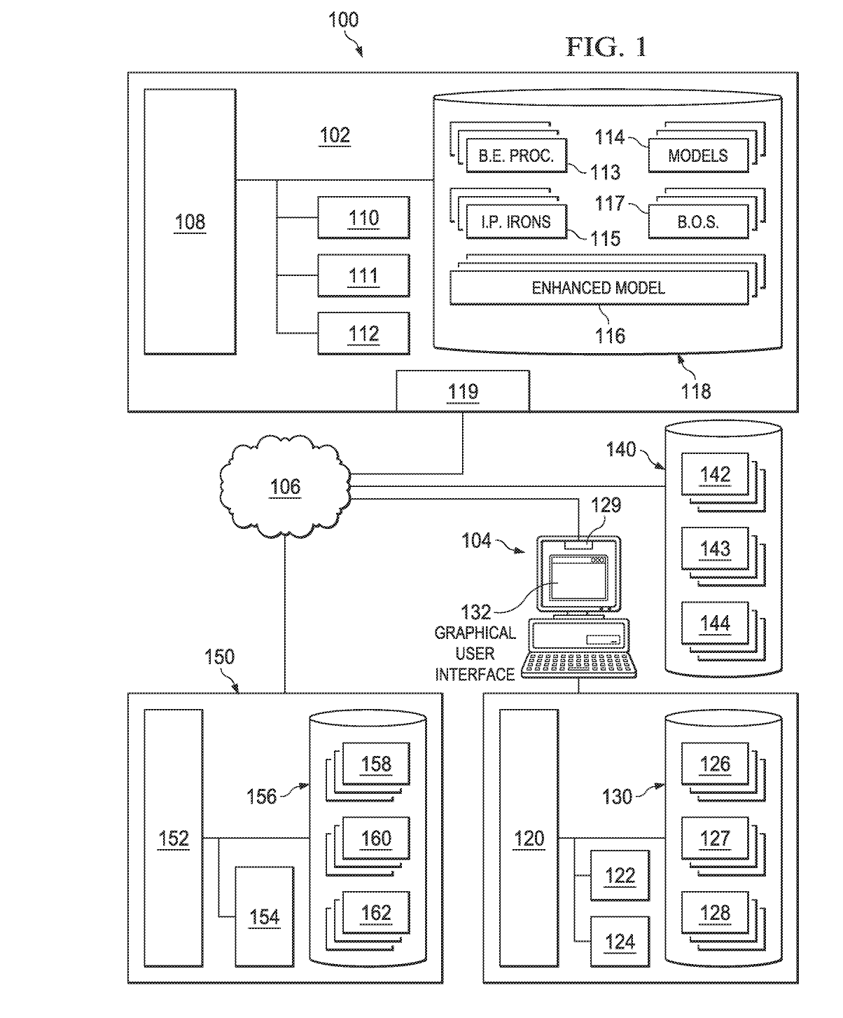

FIG. 1 is a schematic diagram illustrating an example environment 100 for implementing various features of a system for providing BPMN extensions for integration processes. The illustrated environment of FIG. 1 includes a BPMN server 102 and one or more clients 104. The one or more clients 104 may communicate or interface with BPMN server 102 across a network 106. The illustrated environment 100 also includes a remote memory 140 for storing information accessible across the network 106. BPMN server also includes a BPMN modeling application 110 and a BPMN execution engine 112.

BPMN server 102 includes one or more processors 108, a memory 118, and an interface 119. In some instances, the BPMN server 102 and its illustrated components may be separated into multiple components executing at different servers and/or systems. Thus, while illustrated as a single component in the example environment 100 of FIG. 1, alternative implementations may illustrate the BPMN server 102 as including multiple parts or portions accordingly.

FIG. 1 depicts a server-client environment, but could also represent a cloud-computing network based on particular deployment options. Various other implementations of the illustrated environment 100 can be provided to allow for increased flexibility in the underlying system, including multiple BPMN servers 102 performing or executing one or more additional or alternative instances of the BPMN modeling application 110 (for instance, in different IT landscapes), as well as other applications associated with or related to the BPMN modeling application 110, including those illustrated as included as part of the BPMN modeling application 110. In those instances, the different BPMN servers 102 may communicate with each other via a cloud-based network or through the connections provided by network 106.

The interface 119 is used by the BPMN server 102 to communicate with other systems in a client-server or other distributed environment (including within environment 100) connected to the network 106 (e.g., one of the clients 104, as well as other systems communicably coupled to the network 106). The interface 119 generally comprises logic encoded in software and/or hardware in a suitable combination and operable to communicate with the network 106. More specifically, the interface 119 may comprise software supporting one or more communication protocols associated with communications such that the network 106 or the interface's hardware is operable to communicate physical signals within and outside of the illustrated environment 100.

Generally, the BPMN server 102 may be communicably coupled with a network 106 that facilitates wireless or wireline communications between the components of the environment 100 (i.e., between the BPMN server 102, one or more clients 104, and/or the one or more enterprise backend systems 150), as well as with any other local or remote computer, such as additional clients, servers, or other devices communicably coupled to network 106, including those not illustrated in FIG. 1. In the illustrated environment, the network 106 is depicted as a single network, but may be comprised of more than one network without departing from the scope of this disclosure, so long as at least a portion of the network 106 may facilitate communications between senders and recipients. In some instances, one or more of the components associated with the BPMN server 102 may be included within the network 106 as one or more cloud-based services or operations.

The network 106 may be all or a portion of an enterprise or secured network, while in another instance, at least a portion of the network 106 may represent a connection to the Internet. In some instances, a portion of the network 106 may include a portion of a cellular or mobile data network or other network capable of relaying short message service (SMS) or multimedia messaging service (MMS) messages, as well as other suitable mobile data messaging. In some instances, a portion of the network 106 may be a virtual private network (VPN). Further, all or a portion of the network 106 can comprise either a wireline or wireless link. Example wireless links may include 802.11a/b/g/n, 802.20, WiMax, 3G, 4G (i.e., LTE), and/or any other appropriate wireless link. In other words, the network 106 encompasses any internal or external network, networks, sub-network, or combination thereof operable to facilitate communications between various computing components inside and outside the illustrated environment 100. The network 106 may communicate, for example, Internet Protocol (IP) packets, Frame Relay frames, Asynchronous Transfer Mode (ATM) cells, voice, video, data, and other suitable information between network addresses. The network 106 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the BPMN server 102 includes a processor 108. Although illustrated as a single processor 108 in the BPMN server 102, two or more processors may be used in the BPMN server 102 according to particular needs, desires, or particular embodiments of environment 100. The processor 108 may be a central processing unit (CPU), a blade, an application specific integrated circuit (ASIC), a field-programmable gate array (FPGA), or another suitable component. Generally, the processor 108 executes instructions and manipulates data to perform the operations of the BPMN server 102 and, specifically, the functionality associated with the corresponding business process (such as that defined by BPMN model 114 or enhanced BPMN model 116 (enhanced by integration process definition 115)). BPMN models can be stored on server 102 or may be stored elsewhere, such as at the client 104, on a remote server associated with enterprise backend system 150, or on a remote memory 140. BPMN model 114 is similar to BPMN models stored elsewhere, such as BPMN models 126, 142, and 158. Similarly, integration process definition 115 may be similar to those stored elsewhere, such as integration process definition 127, 143, and 158. Enhanced BPMN models may be stored on the server 102 or elsewhere, and enhanced business process model 116 may be similar or the same as enhanced business process models 128, 144, and 162. In one implementation, the server's processor 108 executes the functionality required to receive and respond to requests and instructions from the client 104, as well as the functionality required to perform the operations of the associated business processes 113 and applications among others.

Regardless of the particular implementation, “software” may include computer-readable instructions, firmware, wired or programmed hardware, or any combination thereof on a non-transitory medium operable when executed to perform at least the processes and operations described herein. Indeed, each software component may be fully or partially written or described in any appropriate computer language including C, C++, Java™, Visual Basic, ABAP, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In some instances, a particular BPMN server 102 may be associated with the execution of two or more BPMN models (and other related components), as well as one or more distributed applications executing across two or more BPMN servers 102.

In some instances, the business processes 113 may be defined as business process models using an appropriate syntax or format, such as BPMN. The business process models 114 can in some instances be executed directly at runtime, at which time a runtime compiler (such as engine 112) or other suitable component can interpret the models and execute the corresponding business processes 113 accordingly. In other instances, the business process models 114 may be compiled into an appropriate process binary or other runtime format, allowing a runtime component to interpret and execute the compiled business processes.

The set of business processes 113 is the set of stored business processes defined within or associated with the BPMN server 102 for use in one or more applications 111. In some instances, business processes 113 can be shared between different systems, such as when various IT infrastructures and/or landscapes execute different instances of the same business processes 113. In some instances, the business processes 113 can be created in a different system and imported into memory 118, as appropriate. Client 104 may run a local application 124 to execute business processes 128 stored locally or execute business processes 113 from BPMN server 102. Similarly, client 104 can run an instance of application 113 through a user interface 132 (such as a website or other UI) using remote application 111.

Accordingly, a sequence of symbols expresses the processing chain (often also referred to as a pipeline or route in the literature) for a message within an integration solution. In particular, business processes 113 communicate with other users, applications, systems, and components to send and receive events/messages, while processing the data associated with these communications to perform one or more operations and tasks. Business process steps may be automated steps (e.g., calling a service) or an interactive step (e.g., calling a user interface and requesting user input). The enhanced business model 116 is typically driven by user interfaces (UIs) executed with each business process 113 and the business process steps within each business process 113. In some instances, a particular enhanced business model 116 can operate in response to and in connection with one or more requests received from an associated client 104 or other remote client. Additionally, a particular enhanced business model 116 may operate in response to and in connection with one or more requests received from other business processes 113 outside of the enhanced business model 116, as well as from other enhanced business model 116. In some instances, each enhanced business model 116 may represent a web-based application accessed and executed by remote clients 104 via the network 106 (e.g., through the Internet, or via one or more cloud-based services associated with the enhanced business model 116). Further, while illustrated as internal to the BPMN server 102, one or more processes associated with a particular enhanced business model 116 may be stored, referenced, or executed remotely. For example, a portion of a particular enhanced business model 116 may be a web service that is remotely called, while another portion of the enhanced business model 116 may be an interface object or agent bundled for processing at a remote system (not illustrated) or client 104 (e.g., the client application 124). Moreover, any or all of a particular enhanced business model 116 may be a child or sub-module of another software module or enterprise application (not illustrated) without departing from the scope of this disclosure. Still further, portions of the particular enhanced business model 116 may be executed or accessed by a user working directly at the BPMN server 102, as well as remotely at a client 104.

The business processes 113 included in and performed by the enhanced business model 116 in the present illustration can be business processes built by business experts, created independent of the existing IT and/or service landscape. In service-oriented architectures (SOA), new business processes are built to be dependent on particular services already available in the environment. When the environment changes in a SOA-based process, the implemented process may stop functioning correctly and/or as intended after the modification. Therefore, the business processes 113 described in the present implementation are top-down, or, restated, place the focus upon the process's corresponding business functionality, as opposed to its possible implementation environment or IT landscape.

Memory 118 of the BPMN server 102 stores data and program instructions. Memory 118 may include any memory or database module and may take the form of volatile or non-volatile memory including, without limitation, magnetic media, optical media, random access memory (RAM), read-only memory (ROM), removable media, or any other suitable local or remote memory component. Memory 118 may store various objects or data, including classes, frameworks, applications, backup data, business objects, jobs, web pages, web page templates, database tables, processes, process contexts, repositories storing services local to the BPMN server 102, and any other appropriate information including any parameters, variables, algorithms, instructions, rules, constraints, or references thereto associated with the purposes of the BPMN server 102. In some implementations, including a cloud-based system, some or all of memory 118 may be stored remotely from the BPMN server 102, and communicably coupled to the BPMN server 102 (i.e., via network 106). As illustrated, memory 118 includes a set of business processes 113, the one or more business process models 114, one or more integration processes definitions 115, enhanced business process models 116, and business objects for storing data 117.

Similarly, memory 130, which is local to the client 104, can store business process models 126, integration processes definitions 127, and enhanced business process models 128, as well as data associated with business and/or enterprise systems associated with the business processes 113. FIG. 1 also depicts an enterprise backend system 150 that includes memory 156, which is similar to memory 118. Memory 156 can store business processes 158, data 160 associated with business processes. FIG. 1 also shows a remote memory 140 that can store business models 142, integration processes definitions 143, and enhanced business process models 144. The server 102 and/or the client 104 may rely on remote storage for access to the business models and process integration definitions for defining enhanced business models, and can store the enhanced business models on the remote memory 140.

The illustrated environment 100 includes one or more clients 104. The clients 104 may generally execute in environment 100, capable of interacting with the one or more of the BPMN server 102, the remote memory 140, and/or the enterprise backend system 150. Each client 104 may be any computing device operable to connect to or communicate with at least one of the aforementioned components using a wireline or wireless connection, via the network 106, or another suitable communication means or channel. In some instances, the client 104 may be a part of or associated with a business process involving one or more of the business processes 113.

In general, each client 104 includes a processor 120, an interface 129, a client application 122, a graphical user interface (GUI) 132, and a memory 130. In general, the client 104 comprises an electronic computer device operable to receive, transmit, process, and store any appropriate data associated with the environment 100 of FIG. 1. It will be understood that there may be any number of clients 104 associated with, or external to, environment 100. For example, while illustrated environment 100 includes a single client 104, alternative implementations of environment 100 may include multiple clients 104 communicably coupled to the one or more of the systems illustrated. In some instances, one or more clients 104 may be associated with administrators of the environment, and may be capable of accessing and interacting with the settings and operations of the BPMN server 102, the BPMN modeling application 110, one or more business processes 113 and its associated components, and/or one or more of the enterprise systems 150, and/or other components within the environment 100. Additionally, there may also be one or more additional clients 104 external to the illustrated portion of environment 100 capable of interacting with the environment 100 via the network 106. Further, the terms “client” and “user” may be used interchangeably as appropriate without departing from the scope of this disclosure. Moreover, while each client 104 is described in terms of being used by a single user, this disclosure contemplates that many users may use one computer, or that one user may use multiple computers.

Client 104 includes a modeling interface 122 that permits a user to model business processes. Modeling interface 122 allows a user to enhance existing business process models 126 with integration processes definitions 127 to create enhanced business process models 128. A user can also use a remote UI, such as modeling interface 110 at server 102, which can be used to enhance business process models 114 with integration processes definitions 115 to create enhanced business process models 116. Similarly, business process model 142 can be enhanced with integration process definition 143 to create enhanced business process model 144. The local modeling application 122 can also make use of business models, integration process definitions, and other data stored remotely at the BPMN server 102 or at a remote storage location, such as memory 140.

The GUI 132 associated with each client 104 may comprise a graphical user interface operable to, for example, allow the user of a client 104 to interface with at least a portion of the BPMN modeling application 110 and/or the business processes 113, and their associated operations and functionality. Generally, the GUI 132 provides the particular user with an efficient and user-friendly presentation of business data provided by or communicated within the system. The GUI 132 may comprise a plurality of customizable frames or views having interactive fields, pull-down lists, and buttons operated by the user. For example, the GUI 132 may provide interactive elements that allow a user to interact with a particular BPMN modeling application 110 or business process 113, as well as other components within and/or external to environment 100. The different portions of the BPMN server's functionality may be presented and accessible to the user through the GUI 132, such as through a client application 124 (in some instances, a web browser). Generally, the GUI 132 may also provide general interactive elements that allow a user to access and utilize various services and functions of a particular BPMN modeling application 110. In some instances, the client application 124 may be used to access various portions of different BPMN servers 102 or business processes 113. In some instances, the client application 124 may be used to access (and the GUI 132 used to view) information retrieved from the memory 118 (i.e., a stored business process 113) via the BPMN modeling application 110 and/or a dedicated process development module or product (not illustrated). In some instances, the client application 124 may be an agent or client-side version of the BPMN modeling application 110. Alternatively, the client application 124 may be used to interact with user input-related tasks associated with the BPMN modeling application 110 and/or particular business processes 113. The GUI 132 may present the information of the client application 124 for viewing and interaction. In general, the GUI 132 is often configurable, supports a combination of tables and graphs (bar, line, pie, status dials, etc.), and is able to build real-time portals, where tabs are delineated by key characteristics (e.g., site or micro-site). Therefore, the GUI 132 contemplates any suitable graphical user interface, such as a combination of a generic web browser, intelligent engine, and command line interface (CLI) that processes information in the platform and efficiently presents the results to the user visually.

As used in this disclosure, each client 104 is intended to encompass a personal computer, touch screen terminal, workstation, network computer, kiosk, wireless data port, smart phone, personal data assistant (PDA), one or more processors within these or other devices, or any other suitable processing device. For example, each client 104 may comprise a computer that includes an input device, such as a keypad, touch screen, mouse, or other device that can accept user information, and an output device that conveys information associated with the operation of one or more BPMN servers 102 and their functionality and/or the client 104 itself, including digital data, visual information, or the GUI. Both the input and output device may include fixed or removable storage media such as a magnetic storage media, CD-ROM, or other suitable media, to both receive input from and provide output to users of client 104 through the display, namely, the GUI 132. The client's processor 120, interface 129, and memory 130 may be similar to or different from those described in connection with the other components illustrated in FIG. 1, although alternative implementations of one or more of these components may be used, as well as implementations where additional components may also be included. Generally, each system may be associated with one or more GUIs (not illustrated), such that users local to the BPMN server 102 can access the functionality of the local component, as well as the remote functionality of the other illustrated components via network 106.

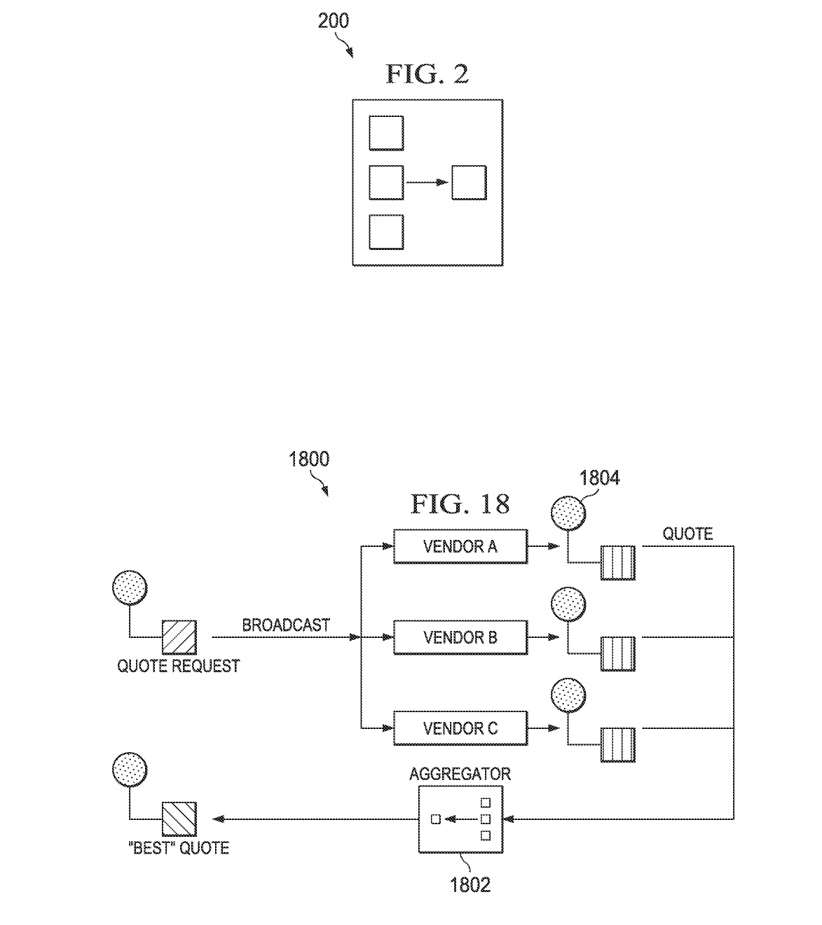

Due to its rich set of technical shapes, BPMN is useful for business processes, and BPMN's wide range of technically-oriented components facilitate the implementation of integration processes as well. An example integration process notation may be based on symbols, where each symbol represents an enterprise integration pattern. An example symbol is shown in FIG. 2 and denotes the Aggregator pattern. FIG. 2 is a graphical representation of an integration process subtask 200. FIG. 2 shows a symbol for the “aggregator integration pattern,” which is described in more detail below.

This example notation (and others like it) lacks certain information or detail pertaining to runtime semantics. For example, if the symbol for the aggregator integration pattern from FIG. 2 is used, then the reader knows that messages are to be aggregated at this point in time. However, the notation does not tell the reader how to implement this aggregation in practice, where the messages come from, or what the final outcome of the aggregator will be. The picture does not indicate when to end the aggregation. Is a previously determined number of messages to be expected? Will the aggregation end automatically after a defined period of time, or will it be ended by an external event?

An enhancement of BPMN with integration process pattern symbolism provides a more useful solution by providing the observer of the model with considerably more information than can be gleaned from the pattern icons alone. After all, a chain of integration patterns is also a type of process, and could thus also benefit from the advantages afforded by BPMN's modeling and expression capabilities, particularly for event processing.

The process integration patterns can be divided into six categories:
Message Channels—How can applications and systems communicate with integration solutions?
Message Construction—How can messages be structured?
Message Routing—How are messages processed within the integration solution? How is the route of the message determined?
Message Transformation—How can systems and applications with different data formats communicate?
Message Endpoints—How can applications and systems not originally intended to be used for integration scenarios be enabled to participate in such?
System Management—How can it be ensured that the integration scenarios are implemented correctly and monitor their operation?
   BPMN, on the other hand, considers the sequence control of process flows, as well as the associated message flow within the process itself and with external partners in the form of collaboration diagrams. The data handling within a process may be referred to as “dada flow”; the data handling across a process may be referred to as “message flow.” Looking at the categories listed above, “Message Routing” and “Message Transformation” are therefore particularly relevant.

The integration patterns can be integrated into BPMN. Primarily, the task types may be extended by adding a symbol for the relevant integration pattern in the upper left corner of the task to make it more easily recognizable. The result is a BPMN-based domain specific language for integration processes. In certain instances, it may not be sufficient to add a new task to the process flow, and additional details, such as relations to other elements in the form of associations, may make the pattern, and therefore the entire process, easier to understand. In addition, complex patterns, such as the Aggregator pattern, may be implemented in more detail as a subprocess.

Additional information (metadata) can be added to a new task to enable it to be executed in a process engine. To identify additional information (e.g., metadata) to be added to a new task to facilitate execution in a process engine, the Open Source project “Apache Camel” may be used as a reference implementation of the enterprise integration patterns (“EIP”), and the parameterization used for an EIP may also be considered.

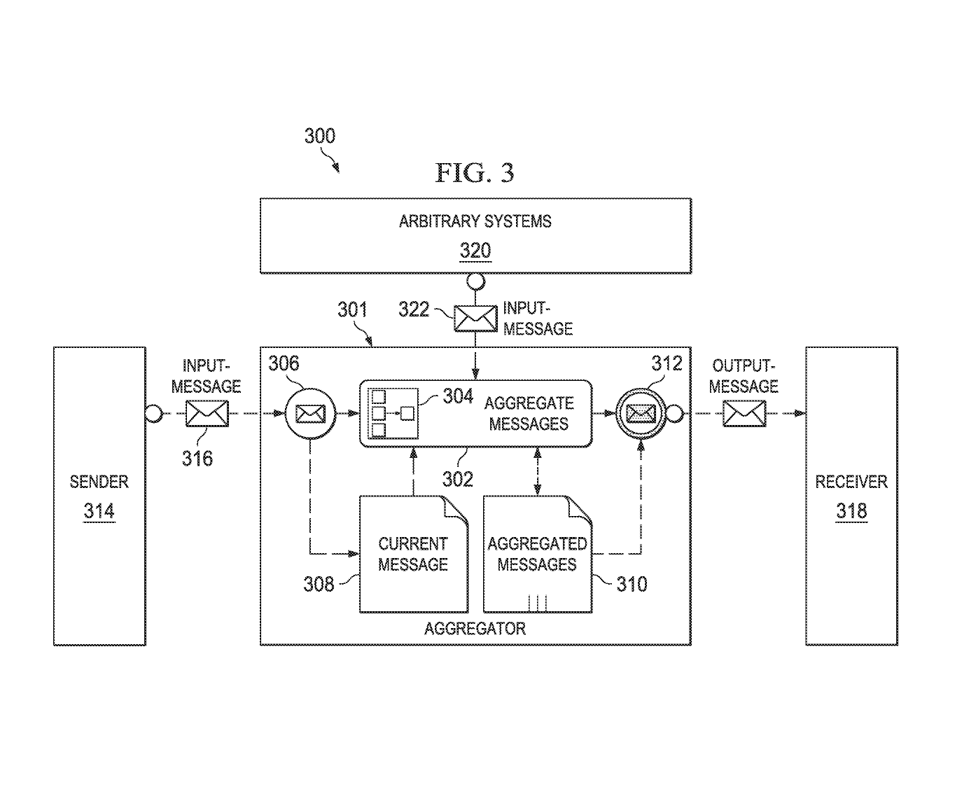

The Aggregator pattern, shown in FIG. 2, will be described below. This pattern, one of the most complex patterns, combines multiple related messages into a single new message. At least three properties are considered for the implementation:
Correlation: Which inbound messages belong together?
Termination condition: When to stop waiting for further inbound messages?
Aggregation algorithm: How are the various messages processed into one new message?
   Rather than simply displaying this pattern as a single new task, a new subprocess can be used. In its collapsed state it simply has the symbol from FIG. 2 in its upper left corner; when expanded, it factors in the details of the implementation and displays the various implementation options graphically. FIG. 3 is a schematic diagram illustrating a compact subprocess view 300 of the Aggregator pattern 304 incorporated into a business process model 301.

FIG. 3 shows a process model 301 that includes the aggregate message subprocess 302 enhanced with the aggregator pattern 304. The process model 301 also includes a data object 308 named Current Message for storing inbound message 316. A data object 310 named Aggregated Messages stores aggregated messages from the aggregate message subprocess 302. The data object 310 is annotated with three vertical lines, indicating that it is a list. In this case, the list stores incoming messages that have been aggregated. Start event 306 and end event 312 indicate the start and end of the process, respectively. Messages 322 may also be received from other systems 320. After aggregation, the aggregated messages are sent to a recipient 318.

FIG. 3 shows the arrival of a first inbound message 316 from a sender 314, which starts the processing. The inbound message 316 is saved in a data object 308 named Current Message, which is also used simultaneously to communicate with the subprocess (the data object has the same name in both models). The aggregate messages subprocess 302 is executed with the aggregate pattern 304 enhancement. Inbound message 316 is stored along with other messages in data object 310 named Aggregated Messages.

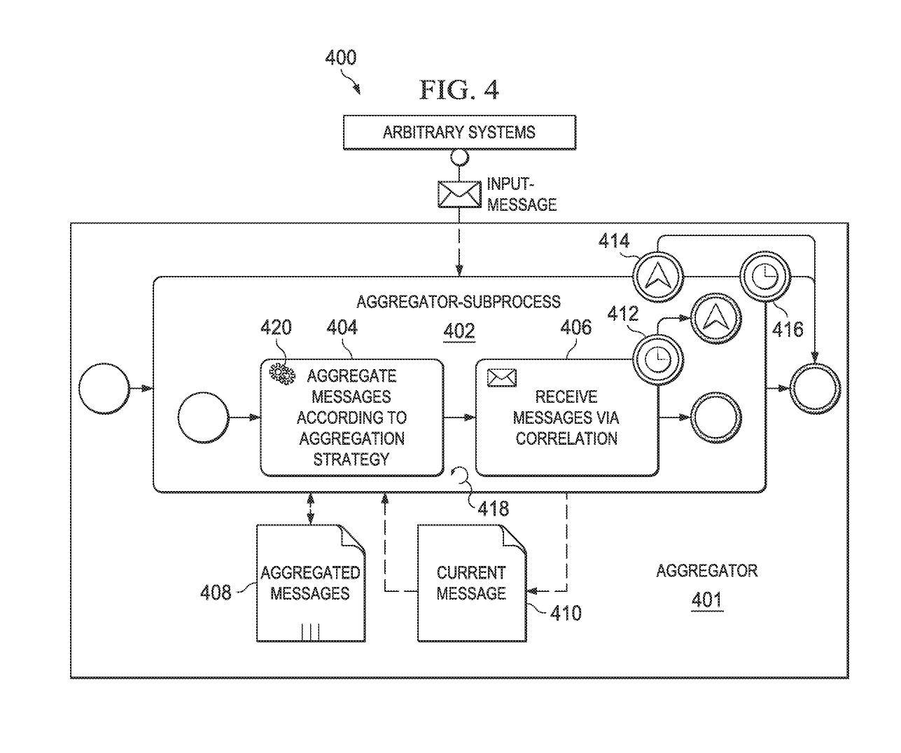

FIG. 4 is a schematic illustration 400 of certain details of the Aggregator Subprocess 401. In FIG. 4, a new message is first added to the list of collected messages, in line with the aggregation strategy, in the Aggregate Messages According to Aggregation Strategy subprocess 404. Aggregate Message According to Aggregation Strategy subprocess 404 is enhanced by a service icon 420 that provides an indication of how the subprocess is to be executed. It is possible for three icons (namely script, business rule, and service) to apply associations for them as well to express how certain tasks are implemented. So those associations can be created for (and associated with) any task, not only for the ones described herein. Next, a receive task 406 waits for further messages (according to a predetermined setting, indicated by timer 412), and once these are received and the correlation condition is met, they are added to the collection list, again following the aggregation strategy.

The fundamental configuration properties of the Aggregator pattern mentioned above (correlation, termination condition, and aggregation algorithm) can now be brought into the process model in FIG. 4 as follows:

The correlation is defined as a property of the receive task 406. This definition can be formulated, for example, using a script. The aggregation algorithm, which determines how inbound messages are combined, is assigned to the aggregation strategy service task 404, and references a component that adds the new data to the existing composite message. This can also be a script. A possible alternative is to use JavaBeans. The termination condition can then be implemented. Four termination criteria have been identified, which can be used in the model:
Termination when a particular number of messages is reached (completion size): This condition can be saved as a property of the Aggregator subprocess from FIG. 4 and then used as a criterion for the standard loop 418 (shown as a curved arrow).
Termination if no further messages have arrived after a particular period of time (completion timeout): This condition is shown Error! Reference source not found. by the interrupting timer intermediate event 412 attached to the receive task.
Termination at a particular time (completion interval): In the model, this is shown by the interrupting timer intermediate event 416 attached to the Aggregator subprocess. Once the target time for the entire processing is reached, the loop of the subprocess is interrupted, thus ending the entire message handling.
Termination of a condition resulting from the message content (completion predicate): A content-related condition can be added to the attributes of the Aggregator subprocess in FIG. 4. To formulate such a condition, a script can be used or, since it relates to the content of the message, an XPath expression. This also serves as a termination criterion for the standard loop 418.
   The various termination conditions may be taken individually, or in combination.

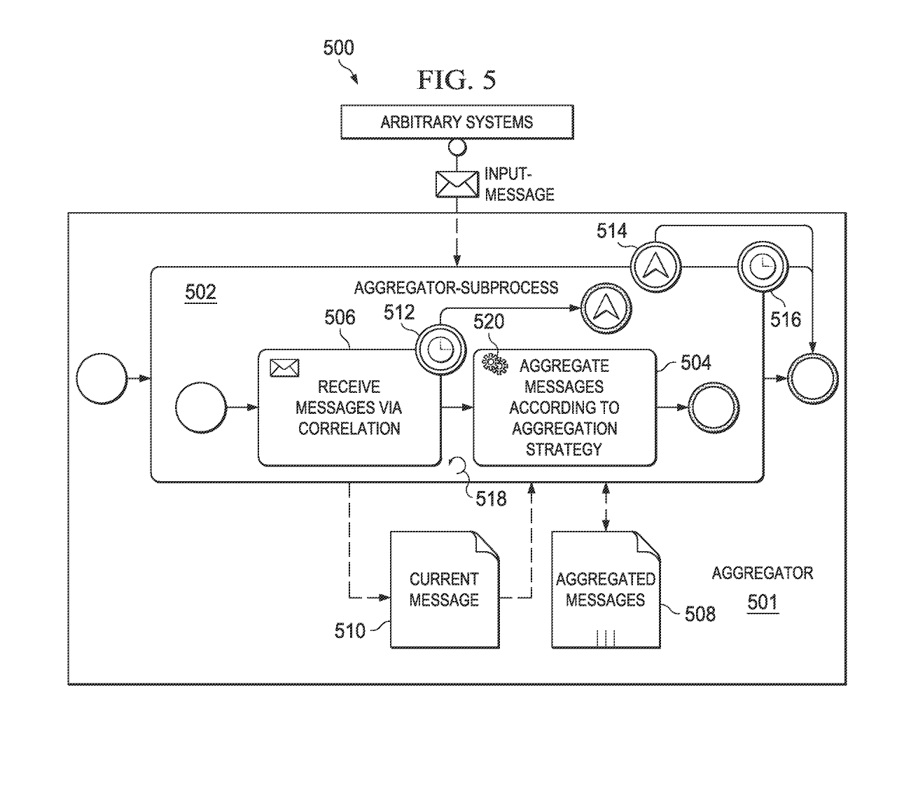

If the Aggregator pattern is used in a processing chain that includes other enterprise integration patterns and is not used as the first task in this chain after the receipt of the message, the implementation in FIG. 4 cannot assume that the data object Current Message 410 is already filled. Therefore, the sequence flow in begins with the receipt of the message, before the aggregation strategy can be applied. The model in FIG. 5 incorporates this reasoning. FIG. 5 is a schematic illustration showing the details of the aggregator implementation when using the aggregator in a processing chain. In contrast to FIG. 4 the receive step is the first activity in the subprocess of FIG. 5 as it assumes that no message has been received before calling the subprocess. In FIG. 4 the assumption was that the first message to be aggregated was already received outside of the subprocess. Hence, two versions of the subprocess can be used depending on the fact whether the first message was received outside of the subprocess or whether the first message has to be received within the subprocess.

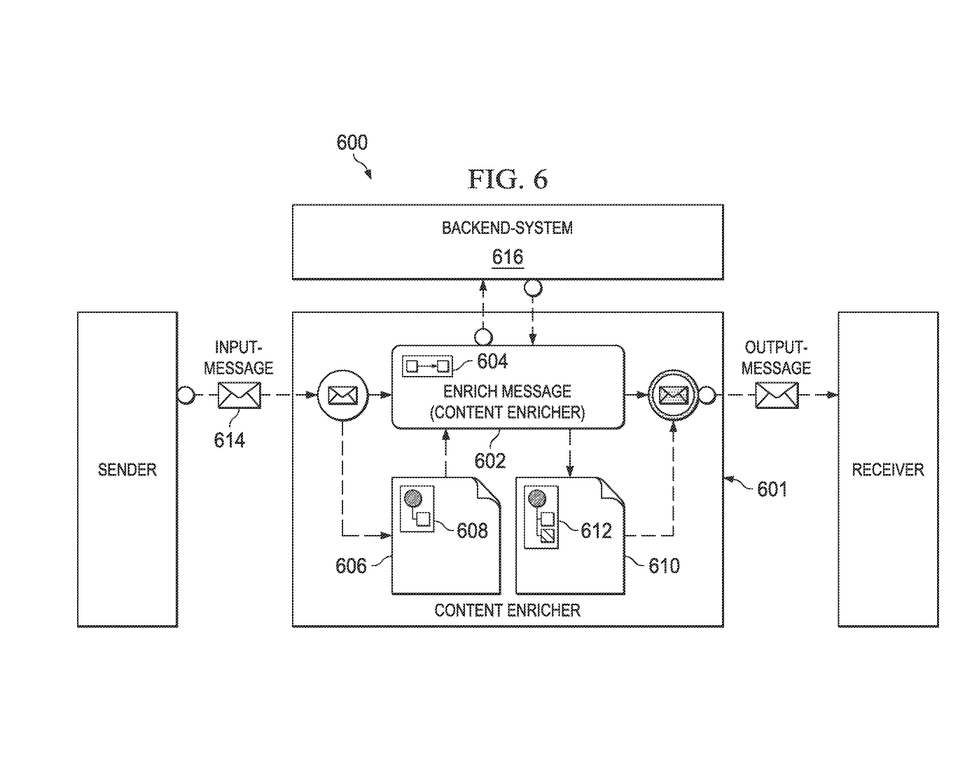

FIG. 6 is a schematic illustration of a BPMN model 600 including a content enricher pattern 604. The aim of the Content Enricher pattern 604 is to supplement the inbound data with information so that the message can be processed by the target system. The sender is often not able to provide all the data required by the target system. In this case, the Content Enricher 602 provides the required data by using a synchronous call. The new BPMN task 601 is shown in FIG. 6.

The Content Enricher task 602 gets the original message 614 as an input parameter, uses another system to procure the missing information 616, then adds this to the original message. This is represented visually by the new symbols 608 and 612 in the upper left corner of the data objects 606 and 610 respectively. These symbols are also part of the symbol language of integration patterns. The symbol 606 in the data object 606 has only one rectangle, but once the data has passed through the Content Enricher, it has an extra rectangle as shown by symbol 612 in data object 610.

To ensure that the new Content Enricher task can be executed, the following two pieces of information must be specified (FuseSource 2011b):
The address of the source from which the additional information is requested. In the above BPMN model, this information could be assigned, for example, to the back-end system pool 616 that the Content Enricher communicates with. It is possible to attach the information to the message flow (dashed arrow from/to the back-end system).
Aggregation strategy: like in the Aggregator pattern, the execution engine must be told how to add the requested data to the original message. The actual functionality can be implemented using a JavaBean or a script. The link to the bean or the script, on the other hand, is part of the properties of the Content Enricher task itself.
   If configured in this way, the Content Enricher can perform its task at runtime.

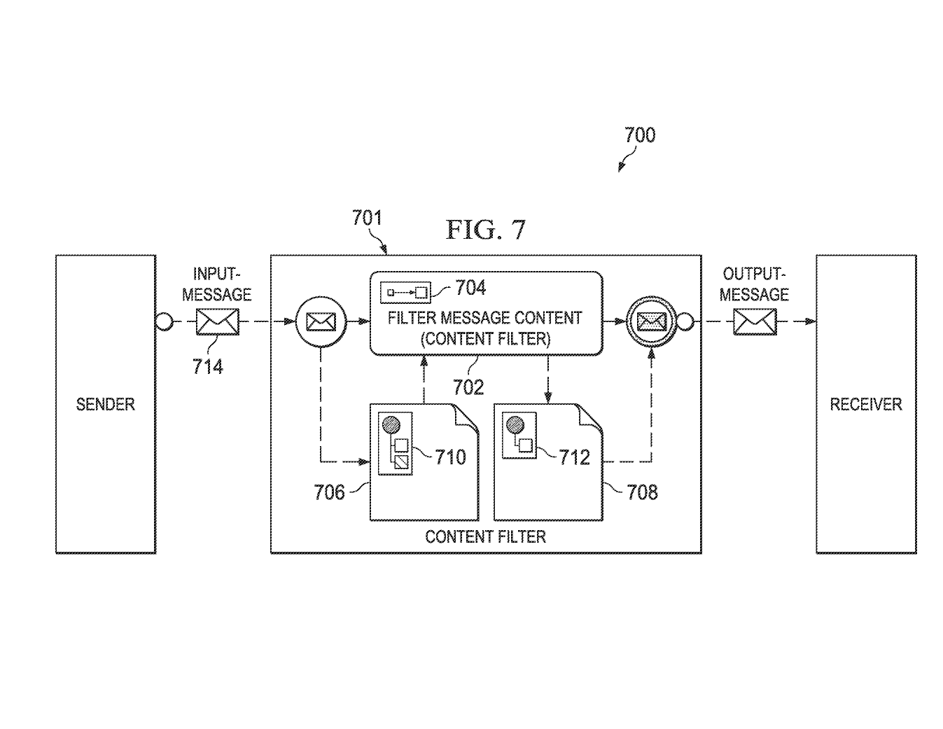

FIG. 7 is a schematic illustration of a BPMN process model 700 incorporating a content filter pattern 704. The Content Filter pattern 704 does the opposite of the Content Enricher: it removes certain components of a message or simplifies the message structure. FIG. 7 shows how the new task is used. How to implement the filter function is known at runtime. Because this process involves a typical message transformation, the function can be implemented as a script language, Java, or in an XSLT (Extensible Stylesheet Language Transformations) transformation. As before, the reference to the implementation is saved in the properties of the Content Filter task. At runtime, the message 714 currently being processed is forwarded to the Content Filter 702 by way of the inbound data object 706. The data object is also enhanced with integration pattern symbol 710. The process 701 then uses the filter function, which simplifies the message accordingly. The resulting message is then forwarded to the outbound data object 708 and finally, using the message-based end event, to the receiver. The symbol of outbound data object 708 is also enhanced using the integration pattern symbol 712, which is slightly different from symbol 710: symbol 712 has one square, whereas symbol 710 has two, indicating the removal of information from the message stored in the outbound data object 708 relative to the message stored in the inbound data object 706.

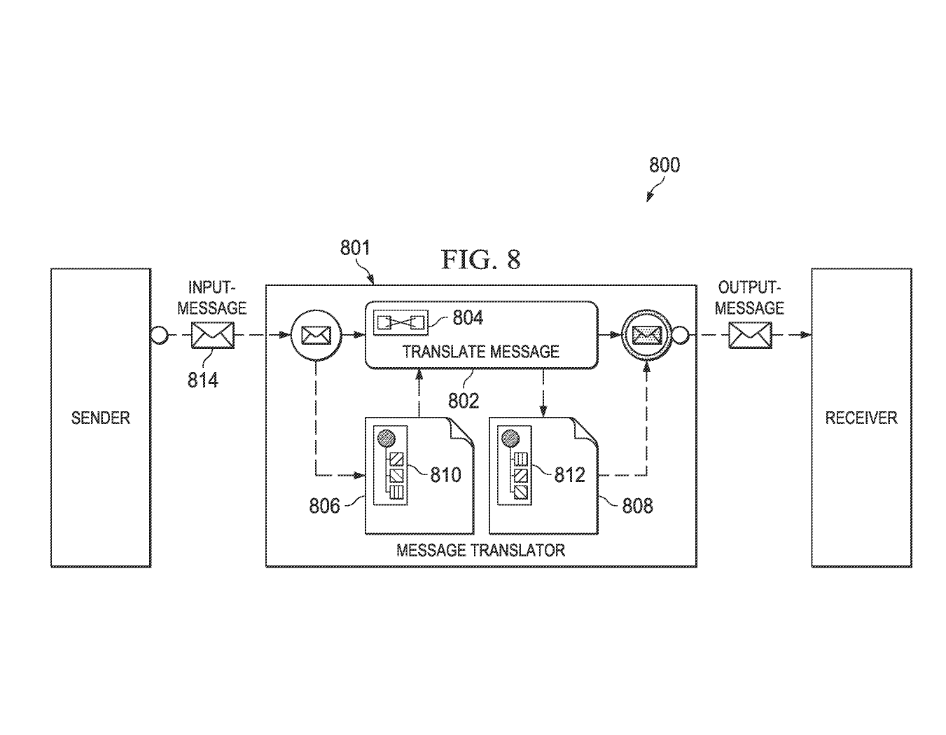

FIG. 8 is a schematic illustration of a BPMN process model 800 incorporating a message translator pattern 804. The Content Enricher and Content Filter patterns both belong to the Message Transformation pattern category, which mainly handles communication between different data formats. This includes the Message Translator pattern, a sort of generalized pattern for this category. This pattern can be used when a transformation is needed between different formats. FIG. 8 shows the pattern incorporated into a business process model.

Whether the message header data or the payload itself is affected, whether the transformation is between the objects and XML (marshall, unmarshall), whether messages are normalized or “packaged” into other structures, the Message Translator can handle all of these possibilities with a reference to the implementation of the transformation logic. Once again, script languages, Java, and XSLT transformations are suitable. The processing at runtime is like that of the Content Filter pattern.

BPMN process model 800 includes a translate message process 801, which includes translate message task 802 (which is enhanced by a message translator pattern 804), a first data object 806 (which is enhanced by a symbol 810), and a second data object 808 (which is enhanced by a symbol 812). The symbol 810 indicates that the data stored in the first data object 806 (e.g., incoming message 814) has a particular format. The translate message task 802 receives the incoming message 814 from the first data object 806 and executes a translation operation on it. The translated message is then stored in the second data object 808. The symbol 812 indicates that the data stored in the second data object 808 is different (i.e., translated) from the data stored in the first data object 806.

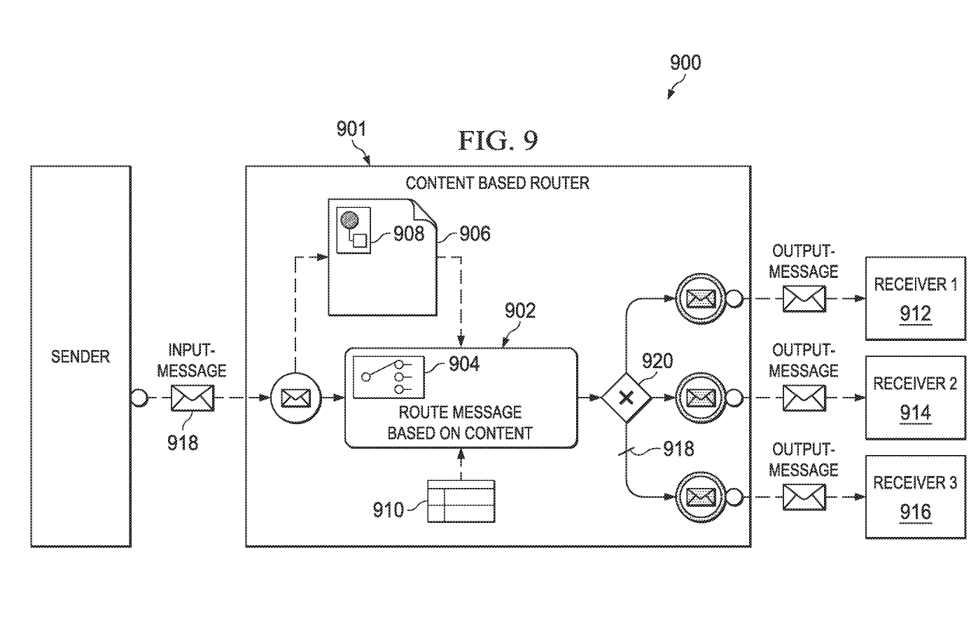

FIG. 9 is a schematic illustration of a BPMN process model 900 incorporating a content-based router pattern 904. The tasks of a Content Based Router process model 901 include transferring a message to exactly one receiver, depending on the content of the inbound message 918. To implement this functionality, a new Content Based Router BPMN task 902 can be combined with an exclusive gateway 920. An expression may be defined for each gate of the gateway to decide whether the message 918 is to be forwarded to the receiver (or to which receiver the message should be forwarded to). This functionality is shown in FIG. 9. FIG. 9 shows that incoming message 918 is first stored in a data object 906 (which is enhanced in this example by a data symbol 908). The message 918 is received by the Route Message Based on Content task 902. Route Message Based on Content task 902 is enhanced with the content-based router integration process pattern 904. The content of the message 918 can be parsed to identify the recipient. In addition, business rules (indicated by the table symbol 910) can be used by the task 902 to further identify the recipient. The gateway 920 can use the information and rules to route the message to a recipient (such as recipient 1 912, recipient 2 914, or recipient 3 916). There can be any number of recipients. The process model 901 also includes a default setting indicator 918, which indicates the standard or default flow that is followed if none of the conditions for routing the message to another recipient can be met.

When formulating conditions, they should not conflict with each other, as the message must be received by one system alone. However conditions are formulated, be it using script languages, JavaBeans/Java programs, XPath expressions, or business rules, the reference to the implementation is saved in the properties of the Content Based Router task. The properties can be displayed graphically by using an association, as shown in FIG. 9 for the use of a business rule in table 910.

The Dynamic Router pattern can be shown in a similar way. The only difference is that the information about the conditions is saved in a database, which is filled when the participating target systems are started. The target systems send a type of notification of attendance to the dynamic router. This notification not only indicates that the receiver is available, it also provides the conditions under which the receiver will accept certain messages. The router adds these conditions to the database table and evaluates them at runtime. As far as the representation as a BPMN task is concerned, the only difference is the association: Instead of the business rule displayed in FIG. 9, the new data store symbol introduced with BPMN 2.0 may be used. Otherwise, the way the Dynamic Router functions at runtime is identical to the Content Based Router: The inbound message is analyzed using the saved routing logic and, depending on how it meets the various conditions, it is forwarded to exactly one assigned receiver. If none of the conditions are met, the message follows the standard flow and is handled accordingly.

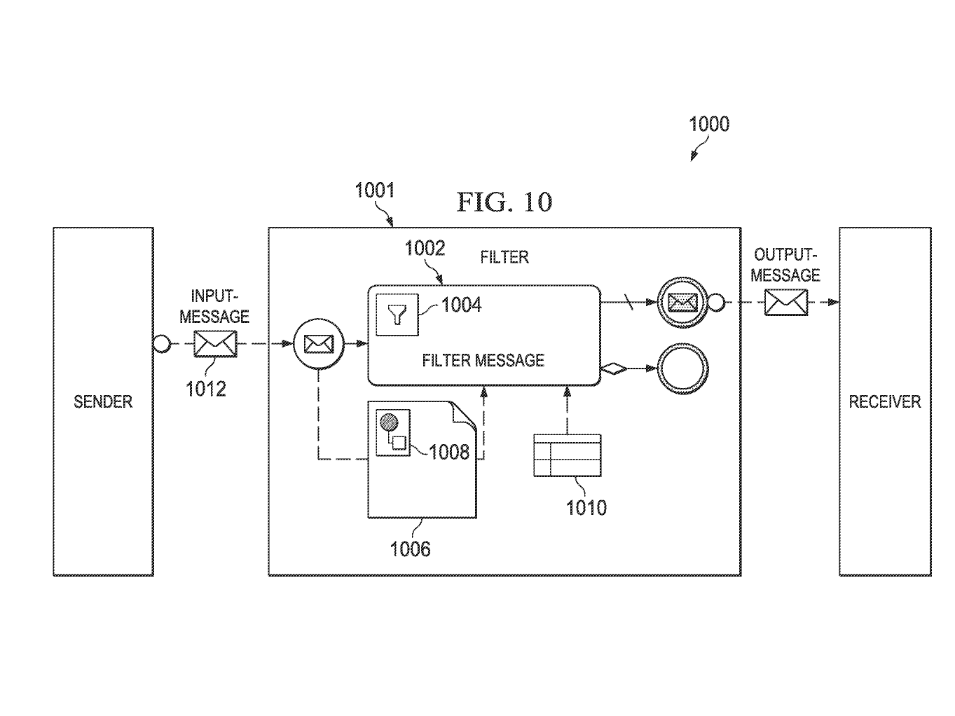

FIG. 10 is a schematic illustration of a BPMN process model 1000 incorporating a message filter pattern 1004. Unlike the Content Filter pattern, which filters out individual parts of a message, the Message Filter pattern removes an unwanted message from the process completely. FIG. 10 shows how this filter is used.

BPMN process model 1000 includes a filter message process 1001. Filter message process 1001 includes a filter message task 1002 that is enhanced with a message filter pattern 1004. An incoming message 1012 is received and stored at a data object 1006 (which is enhanced by a process integration symbol 1008). The message 1012 is received at the filter message task 1002. At runtime, only the conditions that are used to filter out messages are important, as with the Content Based Router pattern. These conditions can be in the form of scripts, JavaBeans, business rules, or (since mainly message content is accessed) XPath expressions, which are referenced in the properties of the filter task. FIG. 10 shows another example of using business rules (e.g., stored in a table 1010). If the filter criterion applies to the message currently being processed, the prescribed sequence flow is followed and the untyped end event is reached, with the result that the message is not forwarded. Otherwise, the standard sequence flow is followed and the message is sent to the receiver by way of the message-based end event.

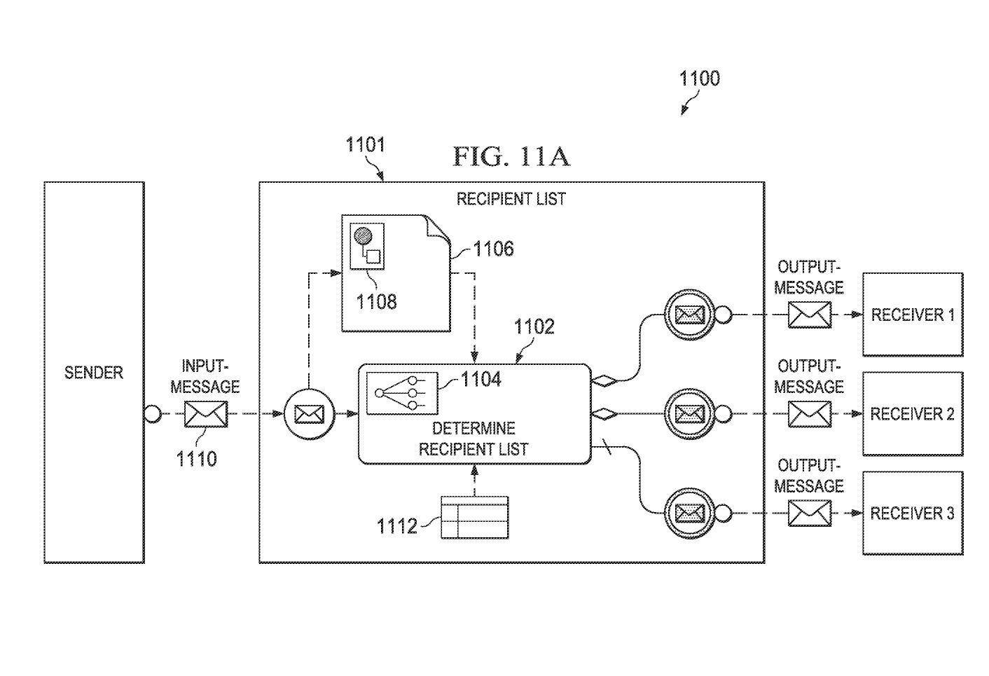

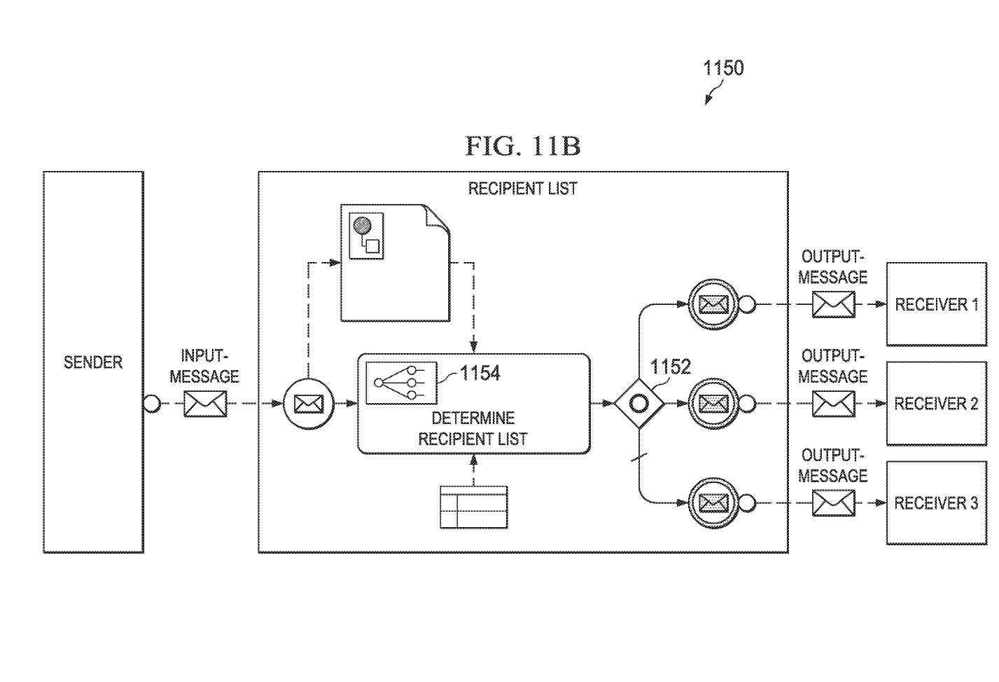

FIG. 11A is a schematic illustration of a BPMN process model 1100 incorporating a recipient list pattern 1104. Unlike the Content Based Router pattern, which forwards a message to just one recipient, the Recipient List pattern 1104 transfers a message 1110 based on its content to a list of recipients (which can be determined, e.g., by a business rule that is indicated by the table symbol 1112). The business rule icon 1112 indicates how the recipient list is derived. To implement this, a combination of the new Recipient List BPMN task 1102 (incorporating the recipient list pattern 1104) and conditional sequence flows. An expression may be defined for each conditional sequence flow, to define whether the message should be forwarded to the recipient that is assigned to the conditional sequence flow. FIG. 11A shows how this works.

Here again, the standard flow ensures that the message is processed further if the conditions are not met. The condition can be formulated in various ways: script languages, JavaBeans/Java programs, XPath expressions, and business rules are all suitable. The reference to the chosen implementation is saved in the properties of the Recipient List task. FIG. 11A shows an example using a business rule. At runtime, the routing logic is calculated and, depending on the condition, the message is forwarded to the assigned receiver or receivers. The standard flow is always used if it is not possible to determine a receiver.

Recipient List pattern can also be implemented using an inclusive gateway, as shown in FIG. 11B. FIG. 11B is a schematic illustration of a BPMN process model 1150 incorporating a recipient list pattern 1154 and an inclusive gateway 1152.

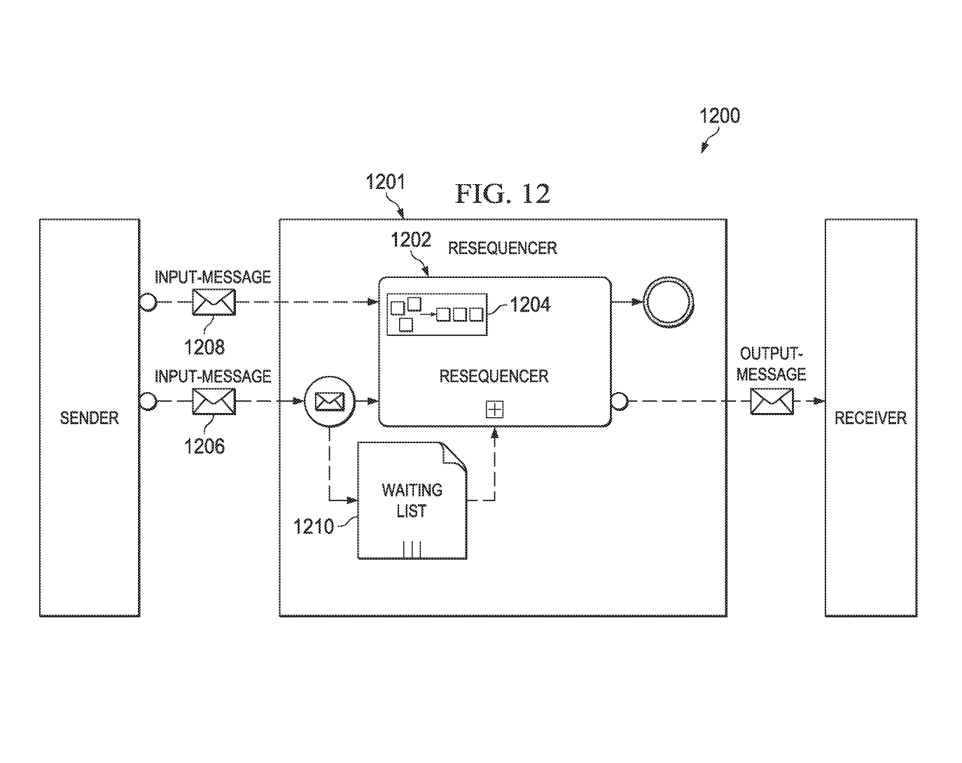

FIG. 12 is a schematic illustration of a BPMN process model 1200 incorporating a resequencer pattern 1204. The Resequencer pattern 1204 is a stateful pattern, as described for the Aggregator pattern. The sequence of messages should reach the receiver in a defined order, but it is not guaranteed that the messages arrive in this order. The task of the Resequencer pattern is to put the individual messages in the correct order. Therefore, the pattern must be able to temporarily store the messages that have arrived in the wrong order. Once the missing messages have arrived, the whole sequence can be sent. The Resequencer does not buffer all the messages of a sequence, but sends them immediately once a sequence of consecutive numbers is complete. Therefore, it is again useful to split the pattern into two parts. The model in FIG. 12 shows how the pattern is used in a new Resequencer subprocess 1202. A first message 1206 may be received to start the processing. A second message 1208 may be received subsequently.

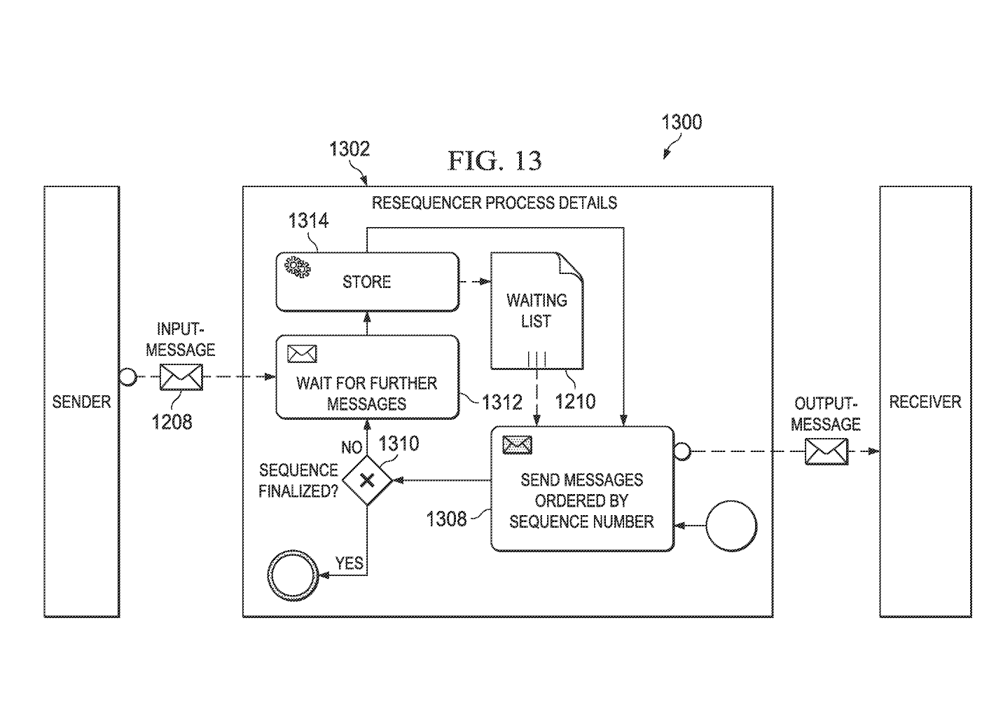

FIG. 13 is a schematic illustration showing the detailed implementation 1300 of the Resequencer subprocess 1202. The Resequencer pattern works at runtime as follows. The inbound message 1208 from the sender in FIG. 12 starts the processing. The message 1304 is copied to a data object called Waiting List 1210. Waiting List 1210 collects all messages that have not yet been sent to the receiver. Waiting List 1210 also establishes the connection to the subprocess implementation in FIG. 13, which accesses the same data object. The send task 1308 in FIG. 13 forwards however many messages there are with successive sequential numbers. Sent messages are removed from the list immediately. Once the send procedure is finished (either because the list is empty or because there is a gap in the sequential numbers), a check is performed at the exclusive gateway 1310 to determine whether the Resequencer can be closed. This is the case if the waiting list 1306 is empty and all expected messages have arrived. In message sequences, the number of expected messages is usually provided as part of the message header. So, each message contains the information about how many messages make up the total sequence. If the sequence is not yet complete, the Resequencer must wait for further messages. The receive task Wait for Further Messages 1312 is responsible for this. If this task is exited, a new message has arrived, which is added to the waiting list by the service task Store 1314. The cycle can then begin again.

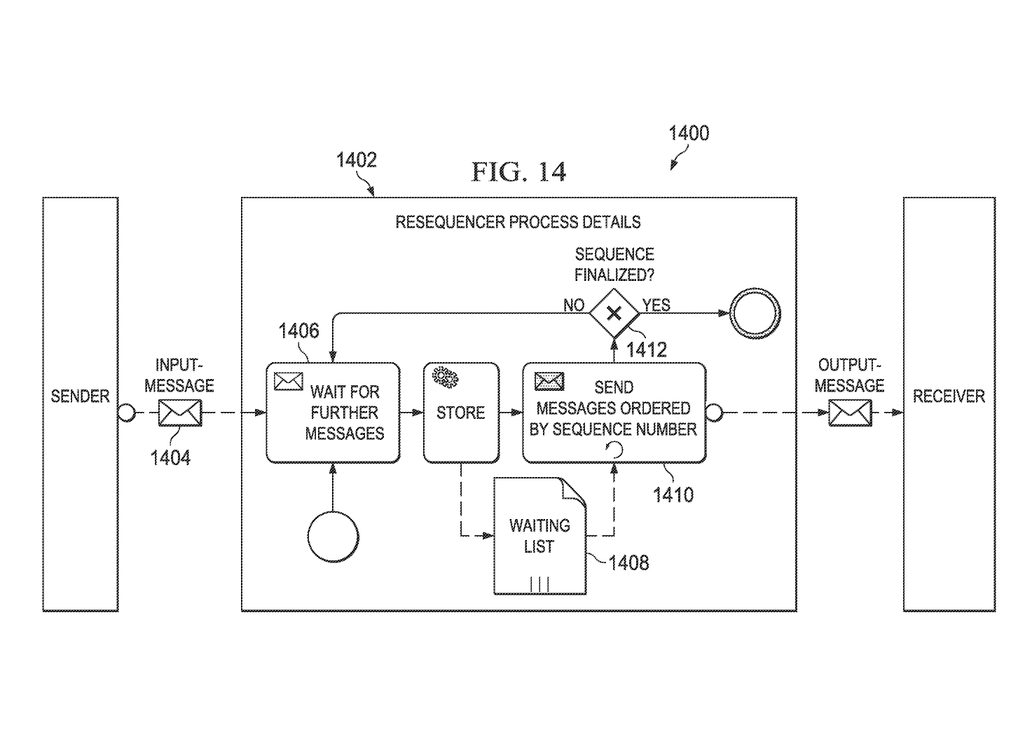

To configure this pattern, the fields within the message are specified for the sequential number and the total number of messages that make up the sequence. However, we still have a problem to solve, one we have already encountered in our discussions of the Aggregator pattern; it relates to the position of the Resequencer pattern within the processing chains: If the Resequencer is used in a processing chain with other enterprise integration patterns and the Resequencer is not at the start of the chain (as is assumed in FIG. 12), it cannot be assumed in the implementation that the first message is already in the waiting list. Instead, a previous pattern could potentially send out one request (or a list of requests) causing a sequence of response messages. The Resequencer has then to receive and sort the replies. In this case, the implementation has to start with the receipt of the message. This is reflected in the implementation in FIG. 14. FIG. 14 is a schematic illustration of an example BPMN process model 1402 incorporating a resequencer pattern with message receipt as the first step. This shift does not affect the underlying logic from that shown in FIG. 13. It ensures that the Resequencer 1402 starts with the receipt of the message and only then proceeds with the send loop. A message 1404 is received and enters a Wait for Further Messages task 1406. Messages are stored in Waiting List 1408 data object. The Send task 1410 is then executed. A gateway 1412 ensures that all messages are received before finalizing the sequence.

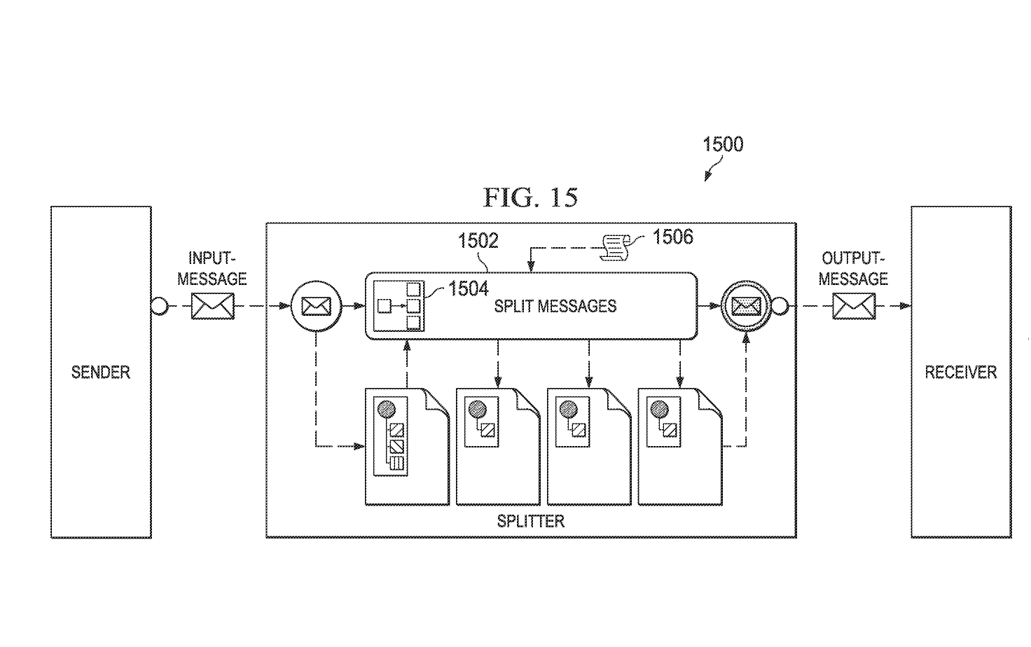

FIG. 15 is a schematic illustration of an example BPMN process model 1500 incorporating a splitter pattern 1504. In real-life scenarios, single messages can often be very complex. Order data, for example, usually contains an order header and several order items. Both the order header and the items are themselves also comprised of a number of other segments. To process such a message, it is often helpful to split it up into its components, so that these can be processed individually, or even in parallel, to improve performance. The Splitter pattern 1504 performs this very task. FIG. 15 shows how this pattern is used. The Splitter 1502 receives the inbound message by way of a data object. The Splitter 1502 then splits the inbound complex structure into different fragments. Each of these fragments can then be processed individually for the rest of the process. In the example shown in FIG. 15, just one message fragment is forwarded to the receiver.

To be able to separate the received structure correctly, all the Splitter needs to know is how to split up the message. This can be done in various ways and depends on the structure of the message itself. For example, each line of a text message can represent exactly one data record; the Splitter 1502 recognizes the end of each entry by the line end marking. Another possibility is that the individual parts are marked with special characters (e.g., @, ;), which the Splitter has to be made aware of. In XML-based messages, a particular tag can be responsible for the splitting. The splitter is provided with this information during configuration. In particularly complex cases, user defined JavaBeans can be responsible for splitting. Whichever method chosen, implementation of it in the model is achieved by using an association, for example, to a script, as in FIG. 15. The properties that represent the type of split are assigned to the association (for example, reference to a JavaBean, special character, or tag). Once configured, the Splitter can perform its task.

FIG. 15 also shows an association between a script icon 1506 and the BPMN task. The expressiveness of BPMN for integration purposes can be enhanced with associations between a task and some other icons to express HOW a certain function is implemented. The dotted arrow from the script icon 1506 to the Split Messages task 1502. The dotted arrow indicates an association in BPMN nomenclature. The script icon 1506 provides an association between the icon 1506 and the task 1502 to express how the splitting is implemented—in this case via a script.

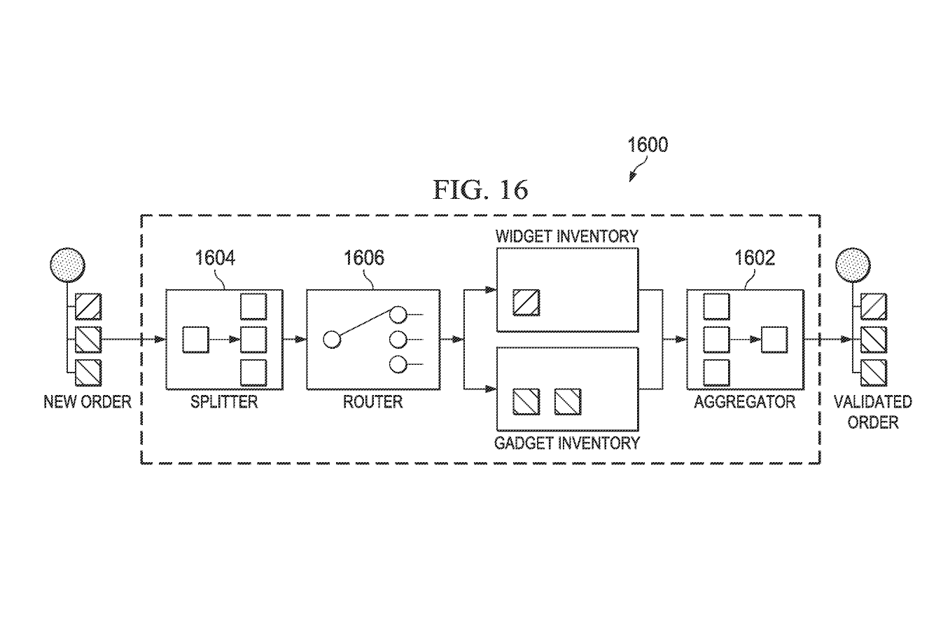

The true extent of the potential of the patterns we have discussed is revealed when they are used in combination with each other. The Composed Message Processor pattern is shown as an example, using the Splitter 1604, Content Based Router 1606, and Aggregator 1602 patterns in sequence. FIG. 16 shows the sequence of these patterns, using the symbol notation. FIG. 16 is a schematic illustration of a composed message processor pattern 1600. As shown in FIG. 16, an inbound messages passes through a Splitter 1604, which first splits the message into several parts. Each of these parts is then sent to one of two possible receivers by the Router 1606 (this is not shown in detail in the model in FIG. 16). The Aggregator 1602 collects the response messages and combines them into a new outbound message. A typical scenario for this pattern would be the validation of the individual items of an order, to check, for example, if the product designated by the item is in stock and thus whether it can be delivered. FIG. 16 shows two types of product and each requires a different inventory check. Once the data contains the validation information, it is forwarded as a message.

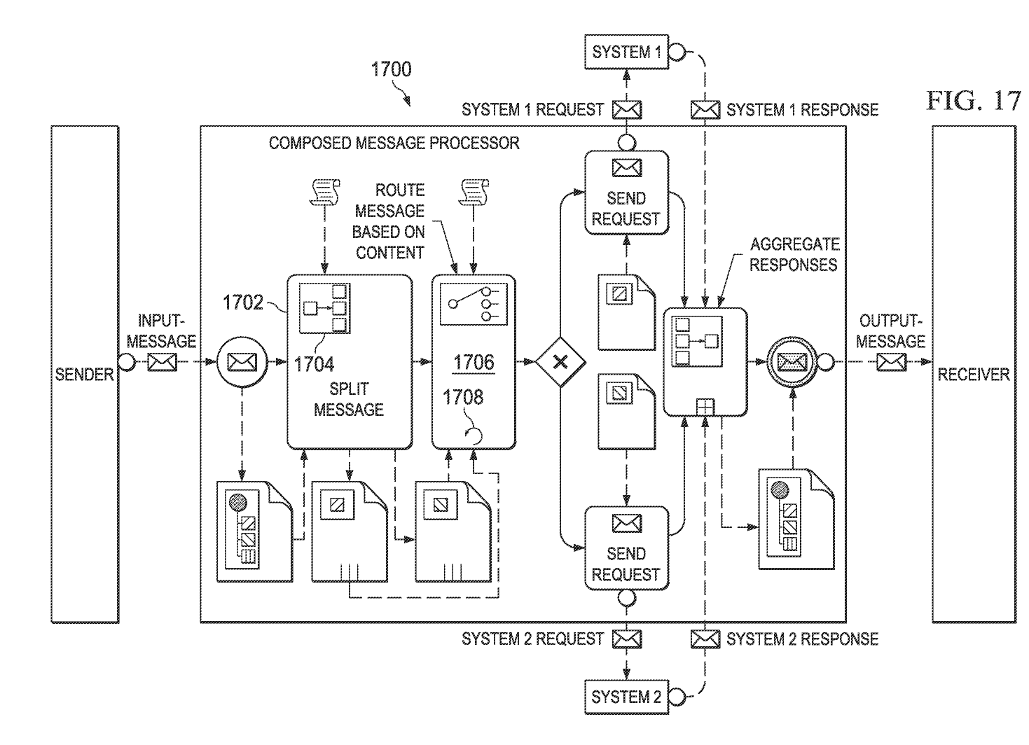

If the model is implemented using extended BPMN, the result is as shown in FIG. 17. FIG. 17 is a schematic illustration of a composed message processor pattern using extended BPMN. The BPMN model 1700 in FIG. 17 is considerably more detailed than the model in FIG. 16. The inbound message is split into two different message parts at the Splitter task 1702 (enhanced by Splitter pattern 1704, and that each part can occur more than once (indicated by the list marker in the data objects). The separate fragments are passed to the enhanced Content Based Router 1706. This has a loop marker 1708, which makes it immediately and explicitly clear that the execution is repeated for each message fragment. At this point, a new token is generated for each message fragment and forwarded to the exclusive gateway. The gateway's sole task is to evaluate the results from the Content Based Router 1706 and forward each data fragment to the respective sender task accordingly. The model clearly shows the following:
The send steps;
The individual message parts that are sent by the respective send tasks;
The involved systems;
The response messages and how they are combined in the Aggregator.
   The Aggregator is not closed until the number of messages it has received corresponds exactly to the original number of requests sent to the involved systems (the end criteria is the reaching of a particular total number of messages). If the patterns, interfaces, communication endpoints, gateways, and so on are then configured as described in the discussions of the individual patterns, the model can then be executed immediately.

FIG. 18 is a schematic illustration of a scatter-gather pattern 1800. The Scatter-Gather pattern 1804 is another example of a combined processing sequence. It combines the parallel sending of a message to multiple systems (broadcast) with an Aggregator 1802 that collects the responses of the involved systems and combines them into one outbound message. The corresponding original model based on the pattern notation is shown in FIG. 18. FIG. 18 uses a process for collecting quotes as an example to demonstrate the Scatter-Gather pattern. A request for a quote is sent by broadcast to three vendors. The responses are bundled by the Aggregator and finally returned to the original caller as a message containing the best quote.

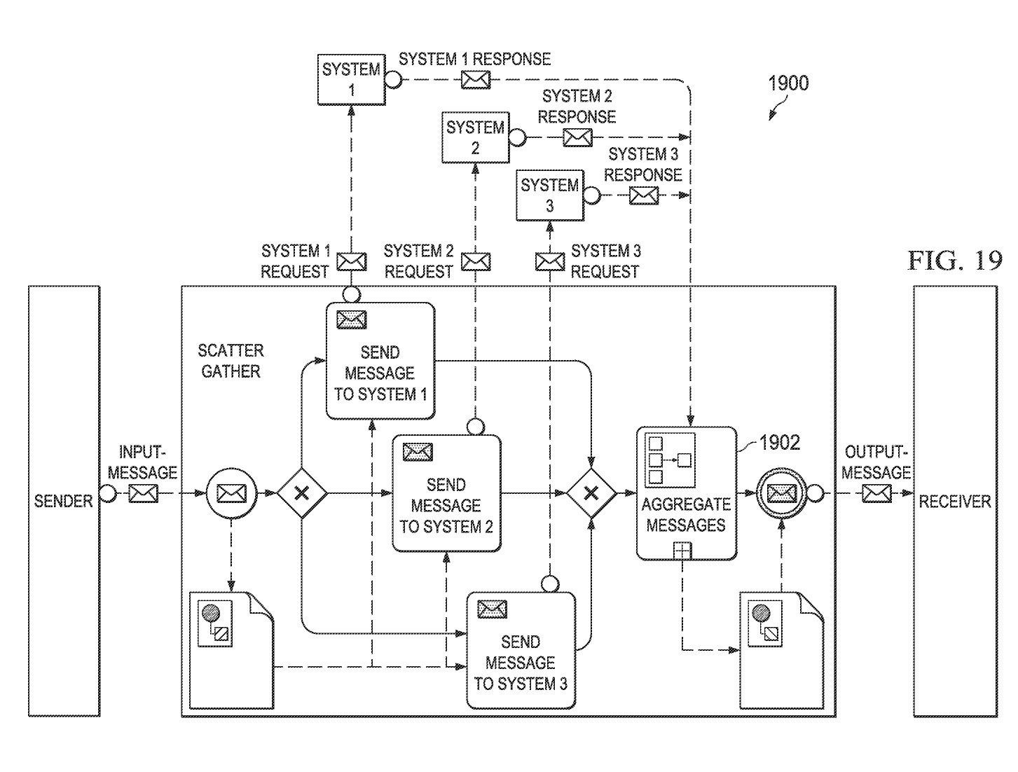

To implement this sequence flow using extended BPMN, a separate pattern is not needed for the broadcast part of Scatter-Gather, as the parallel gateway performs a semantically identical function (see FIG. 19). FIG. 19 is a schematic illustration of a BPMN process 1900 incorporating the scatter-gather pattern using extended BPMN. The enhanced Aggregator subprocess 1902 collects the responses and ends once a particular number of messages is reached.

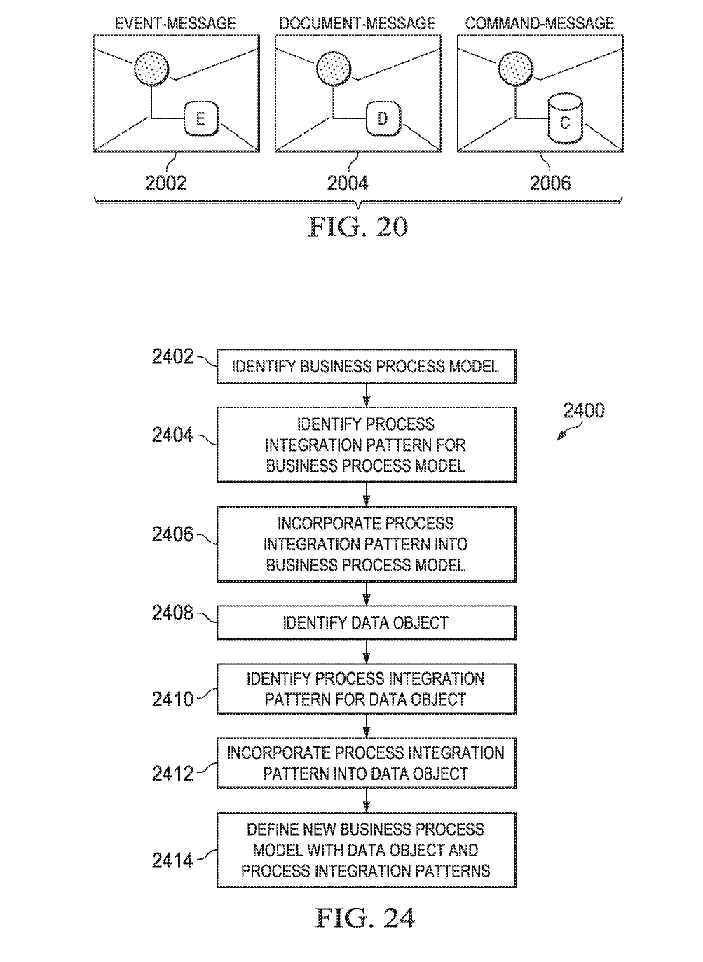

As well as the various integration patterns, new symbols may be introduced for different message types in order to better differentiate them by their content. These symbols differentiate between command messages, document messages, and event messages. Command messages may be used to call a particular procedure or method in a target system. FIG. 20 is a schematic illustration 2000 showing the differentiation of process integration symbols for event-message 2002, document-message 2004, and command-message 2006 patterns in accordance with the present disclosure. An example is creating an order using the command message createOrder. The response to a command message is usually in the form of a document message. However, document messages are not only used in conjunction with command messages: they can also be used if two systems merely need to exchange data (for example, customer or order data). An event message may be used to notify involved systems of status changes where the sender does not know the receivers. Typical events are change notifications to objects, for example, a change of address or the deletion of an order item.

BPMN recognizes the message symbol in the form of an envelope, but does not differentiate further between different message types. However, the differentiation is useful and provides important additional information. It would be appropriate to differentiate between message types in BPMN as well, especially when implementing integration scenarios involving many different types of message. It makes sense to combine the symbols for the various message types with the message symbol in BPMN. The resulting new symbols are shown in FIG. 20.

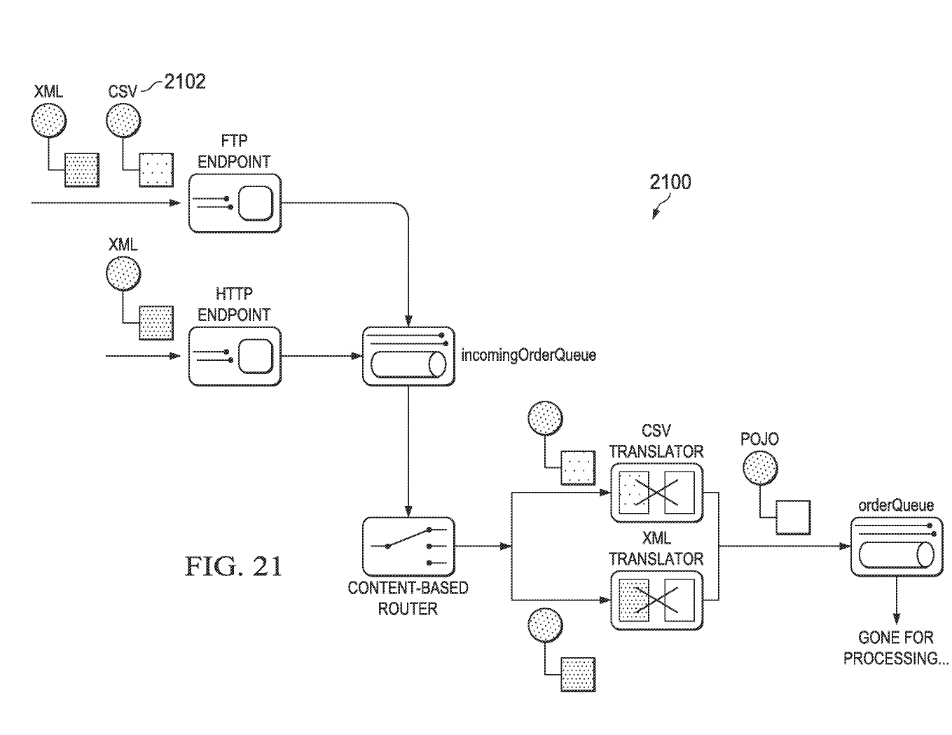

To conclude our discussion of potential BPMN extensions and how they can be used to implement systemcentric processes clearly and concisely, let us look at two integration scenarios that illustrate the use of the new notation. The first example is taken from a tutorial for the Open Source solution Apache Camel. Apache Camel is an integration framework based on the enterprise integration patterns. In his introduction to Camel, Anstey uses a message processing sequence, shown in FIG. 21. FIG. 21 is a schematic illustration of message processing flow 2100 using pattern symbols.

The scenario is as follows:

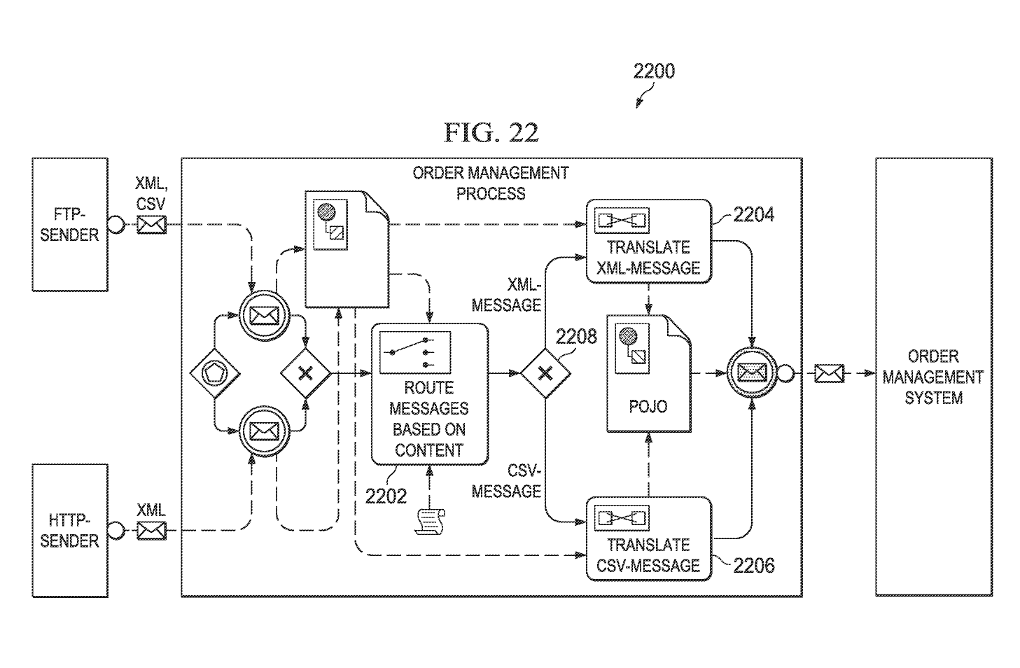

The fictitious company that has implemented this process is a spare parts supplier for motorbikes. The company's customers are chiefly motorbike manufacturers. Over time, the process for ordering spare parts from this company has changed. Originally, an order was saved as a CSV (comma-separated values) file 2102 on an FTP server. In the course of the SOA movement, the range of possible formats was extended to include XML, and the company now offers the CSV format and the XML format for orders. Furthermore, the XML format can be transferred by classic file transfer, or by HTTP. The company recommends that new customers only use HTTP transfer and XML files, but contractual obligations mean that they still have to support the old protocols and the CSV data format. Internally, the order data is processed exclusively as simple Java objects, POJOs (Plain Old Java Objects). Therefore, the company needs to be able to transform inbound orders to POJOs for XML and for CSV content. FIG. 22 is a schematic illustration showing the corresponding process flow 2200, implemented with extended BPMN.

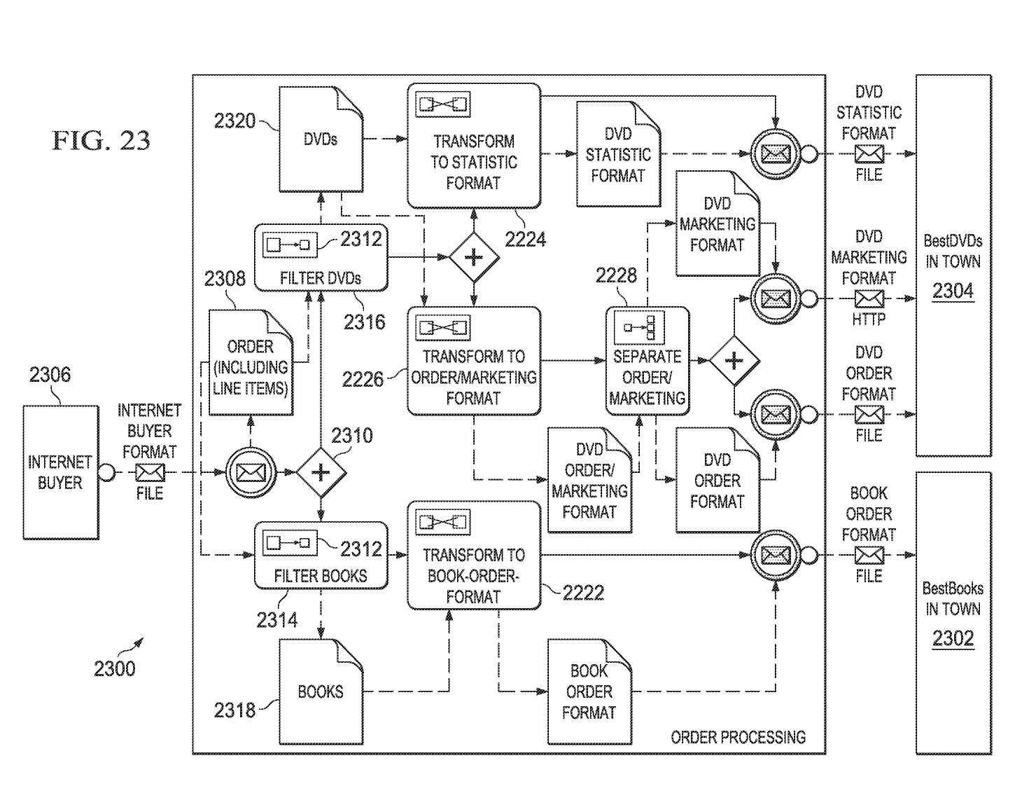

If both models are compared with respect to their use of different integration patterns, the following can be established:
1. The FTP and HTTP endpoints in FIG. 21 can be represented in BPMN by various pools. Technical details could be configured as properties of these pools, for example, the IP address of the responsible FTP server, or logon information for the FTP server (such as user ID/password, X.509 certificates, or SAML tickets). It is also possible to assign these details to the message flows (dashed arrows from pool to start events). We will make use of this approach in the following example.
2. The process should be started as soon as a message arrives at one of the possible inbound channels. In FIG. 21 FIG. this is controlled by a shared incomingOrderQueue. In the corresponding BPMN model, the instantiating exclusive event-based gateway is used. Regardless of how the message arrives, the process is started.
3. An inbound message is routed by the Content Based Router 2202, which forwards it depending on its format to the suitable Message Translator 2204 or 2206. In the BPMN model, an additional gateway 2208 is required because the semantics of following only one path can only be realized by using this gateway. In FIG. 21, the connections from the Content Based Router lead directly to the respective Translator pattern. This is not possible in BPMN because this would express the behavior of a parallel gateway, that is, both paths would receive a token, and this is not required in this scenario.
4. The Message Translator patterns convert the various inbound formats to a POJO. In FIG. 21, the POJO is saved in a queue, from where processing can continue. This is represented in FIG. 22 by the addition of another pool. Here again, the details of the queue used would be saved as pool properties (or as properties of the associated message flow).
   This example shows once again how using extended BPMN enables classic integration scenarios to be implemented clearly, while retaining the conciseness of the original pattern notation. The second example for implementing integration scenarios with extended BPMN is a complex order handling process. This scenario is useful because it combines a range of different message processing steps. Let's have a look at the BPMN model first (shown in FIG. 23).

FIG. 23 is a schematic illustration of complex order processing 2300 using extended BPMN. The process 2300 illustrated in FIG. 23 addresses the following business problem: An Internet shop service provider for books and DVDs receives orders, which it does not deal with itself, but forwards to two suppliers specializing in books (supplier “BestBooks in Town” 2302 in FIG. 23) and DVDs (supplier “BestDVDs in Town” 2304 in FIG. 23). The “BestBooks in Town” supplier 2302 wants to receive book orders only in its target format, on a file server that it provides. The “BestDVDs in Town” supplier 2304 is somewhat more demanding: In addition to the normal order data, it also wants marketing information about which products the buyer has ordered. For its statistics, it also requires aggregated data with information on the total value of products purchased on which day. To make things more difficult, it wants the statistics data to be stored on a different system to the order and marketing data. Although the order and marketing data are sent to the same ERP system, different communication protocols must be used. The marketing data has to be sent by HTTP, the order data by file transfer.

To solve this problem, inbound orders are processed as follows: The order 2306 arrives by file transfer and is first copied to an internal data object Order 2308. This data object provides the basis for the integration process. At the parallel gateway 2310, the differentiation is made between DVD processing and book processing. A Content Filter pattern 2312 (not to be confused with the Message Filter pattern) for each branch filters accordingly: In the book branch (having an integration process-enhanced Filter Books task 1214), the books are extracted from the original message, and in the DVD branch (having an integration process-enhanced Filter DVDs task), the DVDs. The filtered results are stored in separate data objects 2318 for Books and 2320 for DVDs, which are processed independently by the respective branch.

In the book branch, once the books have been extracted all that remains is the transformation to the target format of the book supplier (done in an integration process-enhanced Transform to Book Order Format task 2222). The DVD processing, on the other hand, continues with another parallel gateway, whose transformation steps (enhanced Transform to Statistic Format 2224 and enhanced Transform to Order/Marketing task 2226) perform conversions to the expected target formats of the supplier. The upper branch of the parallel gateway accepts the data for the statistics file. Once the target format has been created for the statistics, the corresponding file can be transferred by file transfer. The lower branch first transforms the data into a data object, which contains both order and marketing data. However, since these two types of data have to be sent separately, they are split by the enhanced Splitter 2228. The order data and the marketing data can then be sent in parallel. The implicit parallel Join behavior of end events means that the process does not finish until all tokens have disappeared from the process. A combining parallel gateway is therefore not required.

The various message formats are hidden behind the envelope between the pools. The message flows (dashed arrows beneath the envelopes) contain the technical information for the endpoints (file server information, HTTP address, and so on). The configuration of the individual patterns has already been discussed in this section. To sum up, the integration scenario in FIG. 23 meets the requirements stated at the outset.

FIG. 24 is a process flow diagram 2400 for defining an enhanced business process model that incorporates a process integration pattern. A business process model can be identified (2402). The business process model can include one or more business processes or subprocesses. A process integration pattern can be identified (2404). The process integration pattern can be identified based, at least in part, on the subprocess(es) used in the business process model. The integration process definition can be incorporated into the business process model (2406). For example, a process integration pattern symbol and definition can be added to the subprocesses of the business process model. A new business process model can be defined based on the original business process model and the process integration pattern identifying an enhanced business process model, the enhanced business process model including the business process model and the integration process definition (2414).

In certain instances, a new data object can be defined based on an original data object for the business process model and a process integration pattern. A data object can be identified (2408). A process integration pattern can be identified for the data object (2410). The new data object can be defined based, at least in part, on the process integration pattern and the original data object (2412). The new business process model can be defined based on the business process model, the new data object, and the process integration patterns (2414).

What is claimed is:

1. A computer implemented method comprising:
identifying a business process model;
identifying an integration process definition;
incorporating the integration process definition into the business process model; and
identifying an enhanced business process model, the enhanced business process model including the business process model and the integration process definition.

2. The computer implemented method of claim 1, wherein the integration process definition is represented as a visual icon.

3. The computer implemented method of claim 1, wherein the integration process definition defines a message aggregation process, the message aggregation process operable when executed to combine multiple messages into a single message.

4. The computer implemented method of claim 1, wherein the integration process definition defines a content enrichment process, the content enrichment process operable when executed to add data to an in-coming message.

5. The computer implemented method of claim 1, wherein the integration process definition defines a content filter process, the content filter process operable when executed to remove data from an incoming message.

6. The computer implemented method of claim 1, wherein the integration process definition defines a message translator process, the message translator process operable when executed to transform data from one form to another form.

7. The computer implemented method of claim 1, wherein the integration process definition defines a content-based router process, the content-based router process operable when executed to route a message to a recipient based on content within the message.

8. The computer implemented method of claim 1, wherein the integration process definition defines a recipient list process, the recipient list process operable when executed to transfer messages to one or more recipients.

9. The computer implemented method of claim 1, wherein the integration process definition defines a message filter process, the message filter process operable when executed to remove a message.

10. The computer implemented method of claim 1, further comprising:
identifying a data object associated with the business process model;
incorporating an integration process definition into the data object; and
storing the data object in association with the enhanced business process model.

11. The computer implemented method of claim 1, further comprising defining an event message type, the event message type enhanced with a integration process definition.

12. The computer implemented method of claim 1, further comprising defining an command message type, the command message type enhanced with a integration process definition.

13. The computer implemented method of claim 1, further comprising defining an document message type, the document message type enhanced with a integration process definition.

14. The computer implemented method of claim 1, further comprising defining an association between a task of the business process model and an implementation icon, the implementation icon identifying how the task is to be performed.

15. The computer implemented method of claim 14, wherein the association is one or more of a service, a business rule, or a script.

16. A computer program product tangibly embodied on non-transitory media, the computer program product operable to execute instructions comprising:
identifying a business process model;
identifying an integration process definition;
incorporating the integration process definition into the business process model; and
identifying an enhanced business process model, the enhanced business process model including the business process model and the integration process definition.

17. The computer program product of claim 16, wherein the integration process definition is represented as a visual icon.

18. The computer program product of claim 16, wherein the integration process definition defines a message aggregation process, the message aggregation process operable when executed to combine multiple messages into a single message.

19. The computer program product of claim 16, wherein the integration process definition defines a content enrichment process, the content enrichment process operable when executed to add data to an in-coming message.

20. The computer program product of claim 16, wherein the integration process definition defines a content filter process, the content filter process operable when executed to remove data from an incoming message.

21. The computer program product of claim 16, wherein the integration process definition defines a message translator process, the message translator process operable when executed to transform data from one form to another form.

22. The computer program product of claim 16, wherein the integration process definition defines a content-based router process, the content-based router process operable when executed to route a message to a recipient based on content within the message.

23. The computer program product of claim 16, wherein the integration process definition defines a recipient list process, the recipient list process operable when executed to transfer messages to one or more recipients.

24. The computer program product of claim 16, wherein the integration process definition defines a message filter process, the message filter process operable when executed to remove a message.

25. The computer program product of claim 16, further comprising:
identifying a data object associated with the business process model;
incorporating an integration process definition into the data object; and
storing the data object in association with the enhanced business process model.
